(19) United States
(12) Patent Application Publication
(10) Pub. No.: US 2003/0130894 A1
(43) Pub. Date: Jul. 10, 2003

(54) System for converting and delivering multiple subscriber data requests to remote subscribers

(76) Inventors: Alison Huettner, Pittsburgh, PA (US); Timothy R. Tresch, Pittsburgh, PA (US); Timothy J. Megela, Pittsburgh, PA (US); Venkateswara R. Ayyadevara, Pittsburgh, PA (US)

Correspondence Address: Cohen & Grigsby, P.C., 15th Floor, 11 Stanwix Street, Pittsburgh, PA, 15222, US

(21) Appl. No.: 10/299,745

(22) Filed: Nov. 19, 2002

Related U.S. Application Data
(63) Continuation-in-part of application No. 09/998,345, filed on Nov. 30, 2001.

(51) Int. Cl. G06F 17/60

(52) U.S. Cl. 705/14; 709/200

(57) ABSTRACT

A system and method for delivering highly customized, natural-sounding/appearing audio and/or visual content to existing player devices, including but not restricted to wired and wireless voicemail, sound-enabled PCs, and portable MP3 or DVD players. Subscribers register with existing content providers to receive alerts and information on topics they care about (e.g., portfolio updates, financial news, sports). If a user selects the audio and/or visual delivery option, the content provider passes his or her registration and preference information to the system. The content providers then pass news information to the system, which converts it to audio and/or visuals in one of two ways. For short, formulaic messages, the system concatenates spoken phrases and clauses previously recorded by human talent and stored in a Multimedia Library database, to create natural-seeming audio and/or visual sequences. For longer messages, the system uses human abilities entirely—i.e., a human reader records a complete text and inputs audio and/or visual files to the system. Turnaround time in both cases is minimal, and quality is high. The system then organizes customized audio and/or visual news deliveries in accordance with user preference information and customizable playlist rules, which order the selected news information by vertical, subject, paragraph, sentence, or other dimension(s). Customized news packages are then delivered as audio and/or visuals to the listeners' player devices.

### CLAIM OF PRIORITY

This application is a Continuation in Part of Application U.S. Ser. No. 09/998,345 filed Nov. 30, 2000.

### FIELD OF INVENTION

The present invention relates to a system for converting and delivering multiple subscriber data requests, and in particular to a system for automated, customized delivery of information in one or more media format customized to preferences set by subscriber and other entities.

### BACKGROUND OF THE INVENTION

Systems for the delivery of information to multiple subscribers are generally known. An example of such a system is a customized delivery of a subscriber's stock portfolio with timely updates over the Internet. Many brokerage houses provide such information to their clients. Many companies also deliver timely news information or specialized information to subscribers or clients of their services. Many of these services provide this information over the Internet or in special newsletters delivered by traditional mail or facsimile devices. While the Internet services are capable of providing almost instantaneous news or information as it is created, it requires the subscriber to be positioned at an Internet appliance, typically a personal computer, to receive the information. Portable devices are also being developed to access the Internet wirelessly. Such devices can provide access to mobile users of these new appliances.

However, many analysts, device manufacturers and users generally agree that mobile appliances such as cellular phones with tiny screens and limited keypad functionality are difficult to use for information retrieval. Such devices may be impossible to use while mobile. This difficulty has limited the acceptance of current mobile wireless data delivery services. One solution proposed to solve the “access” problem is the use of voice command interfaces, especially with cellular telephones. A number of systems have been developed to process text data and distribute it by voice/audio over the telephone.

Especially in the case of audio, providing customizable content delivery to those who have aural “dead zone” time, for example, those focused on a visually guided tasks such as commuting or exercising, can optimize this time or receive useful or needed information in a timely, non-obtrusive manner. Currently, there are few systems that provide anything other than impersonal broadcasts or pre-recorded material. Such systems are unable to provide timely news information that is tailored to the user's particular interests and to deliver that in a mobile format.

Accordingly, it is an object of the present invention to provide a “delivery” system that is economical and scalable by converting textual data into audio and/or visual content for customization before delivery. It is another object of the present invention to deliver information to a plurality of subscribers wherever they are located within minutes of when the information becomes available. Another object of the present invention is to provide subscriber-preferred audio and/or visual information whenever they chose to receive the information. Still another object of the present invention is to organize information into topical categories from which subscribers select preference to receive particular information. It is also an object of the present invention to decrease bandwidth requirements necessary to transport information to a plurality of subscribers by transferring information in the form of data structures to a play module where it is converted into a message using one or more media and delivered to the subscriber's location. It is also another object of the invention to provide a play module that is able to accept data from upstream systems such as the one described herein, or from any other upstream system, the play module able to service a large number of concurrent sessions with subscribers who are retrieving their media presentation.

### SUMMARY OF THE INVENTION

In general, the invention comprises a system and method for the fast delivery to end users of highly customized information in a highly convenient audio and/or visual form.

In one embodiment of the invention, a system is provided for converting and delivering multiple subscriber data requests to each subscriber or end user according to a subscriber's preference. The system comprises a router for accepting a subscriber preference and data in structured and unstructured format from a data source for the subscriber such as news or sports publisher or brokerage house and directing the unstructured data to a conversion means. The structured data is delivered to a distribution agent. The router also constructs a data frame associated with each textual data.

A first conversion means is provided to add location information about converted audio and/or visual output to each data frame associated with each such conversion. Examples of visual data are one or more frames of video, images, or illustrations. Conversion can be accomplished through manual reading or through media conversion software such as text-to-speech software for audio. The converted audio and/or visual data is stored in a database library and is assembled and delivered, when requested by a subscriber, to the subscriber's receiving device. The converted data is stored in a database library.

A distribution agent for receiving structured data and subscriber preference data from the router is provided. It also receives unstructured data frames from the first conversion means. The distribution agent stores the data and prepares distribution lists of subscribers, if no distribution lists are provided by the data source, to receive data according to subscriber preference data. The data distribution lists with embedded user information are delivered to a distribution manager that manages the distribution of subscriber data over at least one network, typically a telecommunications network. The distribution manager also is responsible for delivering to a play module converted unstructured data from the database library before delivery of subscriber data to a subscriber.

In response to a request by the subscriber, a second conversion means, preferably part of the play module, converts said data frame and structured data to audio and/or visuals for playback. The play module sends the converted audio and/or visuals, corresponding to structured and unstructured data, to a subscriber receiver for playback.

The system of the present invention also preferably includes a subscriber profile database and a database for storing advertising frames.

In one preferred embodiment, the invention provides a content selection and distribution system for standard mobile devices as well as mobile multimedia devices such as portable web based appliances and 3G cellular telephones. In this embodiment the system accepts data, such as current news or stock quotes, rapidly converts the data to audio (sentences and paragraphs) and/or visuals (such as one or more frames of video), organizes the data, and distributes data tailored to the interests of users or subscribers requesting to receive it. The audio and/or visual deliveries may be made using data transport or telecommunications network, referred to as a distribution network, and are designed to be playable over any portable or wired digital audio and/or visual device. Playback can occur anytime and anywhere, at the subscribers' convenience.

According to another embodiment, the system is configured to accept data from an application program interface (“API”) integrated into existing alert or news delivery systems at one or more content provider or data source locations, including publishers and content aggregators. The API may also be installed for use with the present invention by entities or other systems, such a corporate e-mail system, that do not currently provide delivery systems. The data generally comprises two categories: subscriber-specific information and topical/news information. Subscriber-specific information includes subscriber identification and requested preferences that can be gathered and packaged by the API. The subscriber would register with a particular content provider and request to receive content topical/news information in audio and/or visual format. Typically, the content provider is remote from the ultimate user of the information such as a subscriber.

Topical/news information includes that information which is available electronically, such as through the Internet or in databases internal to an enterprise. This information is either structured or unstructured. Structured data includes formulaic data and often consists essentially of numbers and/or named entities, for example, stock price updates, breaking sports scores, airline schedule changes or weather announcements. Unstructured data is free text of any length.

A system router accepts the various data from the API in a standard packaged format. The format for structured data may be a frame consisting of a series of slot-value pairs, which are specific to the particular domain. For example, a structured frame for stock price updates could include different slot names and different types of values from the frame for sports scores. Unstructured data can be in a similar frame, but would have one or more slot values that are free text fields of arbitrary length. Both types of frames carry publisher identification, time of publication, domain, and the like.

In this embodiment the router distributes the structured and unstructured data differently within the system. When requested by a subscriber, structured data is converted to audio and/or video by a play module and the audio and/or video is sent to the subscriber's receiving device. The conversion of structured data to audio and/or video is achieved by a second conversion means, preferably a software component of the play module, by assembling segments and placeholders such as paragraph and sentence templates. The system contains a Multimedia Library of audio and/or video segments that can be assembled to form complete audio and/or video sentences. Segments are preferably standardized for such things as a large range of numbers, percentages, dollar amounts, dates, and times; names of all securities, teams, cities, airlines, and weather options that can be covered by structured data frames; and additional linking and relational material. The system further contains a wide range of placeholders, which are used for organizing the segments. A paragraph placeholder is a set of pointers to sentence templates. A sentence template is a set of pointers to sub-templates, that ultimately resolves to a set of pointers to audio and/or video segments that, when played in the sequence defined by the sentence template, constitute one complete audio and/or video sentence (or, occasionally, an audio and/or video fragment, such as a subordinate clause or phrase). Some of the segments are constants, and some are variables—values for the latter are preferably chosen by reference to specific data points in the frame associated with the sentence template. The terms “pointer” and “media segment ID” can be used interchangeably in the following pages if the format required for delivery to subscriber is known.

If visuals are included in the delivery, they can take the form of video segments depicting “talking heads,” recorded and assembled as described above; alternatively, they can be visuals illustrative of the data points communicated by the audio—for example, a pie chart showing the distribution of a subscriber's portfolio, or a calendar indicating the subscriber's travel dates. The latter type of visuals can be created either automatically from the data points in the structured data frame, or manually by human analysts.

Preferably, the audio/video segments are recorded by professional human talent, although automated devices (such as text to speech) may also be used. In a preferred embodiment, the talent carefully reads selected sentences, which are then sliced apart to form the segments. A single sentence template selects only segments recorded by the same reader, or segments that have no associated voice e.g. pauses and breathing sounds. A sentence assembled using segments and a sentence template thus has a natural intonation contour and a specific human voice and face.

Note that each audio/video segment is associated with a corresponding text field. In alternate embodiments, placeholders are used to assemble text, with the text delivered directly (for example, via email) or converted to audio using text-to-speech software, or converted to video or other visuals by automatic methods.

Returning to the preferred embodiment, the router distributes unstructured data to a first conversion means where it is converted to audio and/or video using human talent. In this embodiment the unstructured data news segments, such as a story or summary, are electronically provided to human talent who analyze the content to add categorization information and a summary (if no summary has been provided by the data source). The same or a different human talent reads and records the story and the summary. A digital audio and/or visual version of the recording is stored in the system. Preferably the talent is available on a 24-hour a day basis. The recordings are stored in a database or, preferably, Multimedia Library.

A database stores subscriber-specific information, structured news frames, and unstructured news frames with pointers to complete audio files. Each data frame has a distribution list associated with it. The distribution list specifies the subscribers who are to receive this data. The distribution list contains subscriber-specific information such as contact information and delivery preferences. If no distribution list is provided for a data frame by the data source, a system-internal agent program compares content preferences against the domain and categorization information included in the structured and unstructured data frames, and assembles a distribution list for each structured or unstructured news event. If a distribution list is provided by the data source, the agent program may augment it with subscriber-specific information such as delivery preferences. Distribution lists are divided by distribution network, and the resulting lists of device addresses, with a copy of the associated event frame, are routed to the distribution network-specific play modules.

Also stored in a database are subscriber profiles and advertisement targeting information. The system's distribution agent compares profiles with targeting information, and creates a distribution list of appropriate recipients for each advertisement. These lists are divided preferably by carrier as well and sent to the carrier-specific play modules, together with a pointer to the appropriate audio and/or visual advertisement. However, the advertisements are not played until news frames arrive at the carriers.

Subscribers' news organization preferences are sent to the play modules associated with individual distribution networks separately or as information embedded in distribution lists attached to the data frames. When sent separately, these preferences are not used until the news frames also arrive at the play modules and the subscriber requests the news event.

Each play module has available a local full or partial copy of the Multimedia Library, including all segments, sentence templates, audio and/or video news stories, any other visuals, and audio and/or visual ads and includes a second conversion module. At play time, for example, when the subscriber requests a news delivery or stock market update, the playlist generation rules—a subscriber's organizational preferences, together with default playlist rules which the subscriber has not configured (or which are not configurable)—construct a playlist and manage the frame-to-audio and/or visual conversion.

The playlist is the ordered list of presentation items (price updates, news updates, advertisements, sponsorship messages, etc.) to be played during a single audio and/or visual transmission to a single subscriber. In an embodiment, the play module organizes items received at different times and from different sources into an orderly and pleasing program. The items to be organized have various levels of granularity. An unstructured news item or an advertisement is typically listed as a single item, whereas structured news events are listed at the sentence (or even clause or phrase) level—that is, each sentence is specified individually on the playlist, with the playlist itself organizing the sentences into coherent paragraphs. Playlists are constructed dynamically by the playlist generation rules.

Playlist generation rules order the waiting information by publisher and by domain; within domains, they organize it by topic; they select placeholders at paragraph, sentence, and category level for structured data frames; and they organize the placeholders in such a way as to assemble coherent paragraphs. The sentence templates select audio and/or video segments from the local copy of the Multimedia Library to assemble coherent sentences. As the playlist is assembled, complete audio and/or visual files and discrete audio and/or video segments are played in order to output an organized, customized, natural-sounding presentation tailored to the individual listener.

In another embodiment, the playlist consists of presentation items. Each presentation item consists of paragraphs. A paragraph may be an unstructured data item or constructed from structured data. A paragraph constructed from structured data consists of sentence templates. Each sentence template consists of sub-templates that in turn consist of categories. Each category corresponds to a media segment from the local copy of the Multimedia Library. As in the previous embodiment, playlists are constructed dynamically using playlist generation rules. These playlist rules define how a sentence template is assembled using media segments, how paragraphs are assembled using sentences, and so on.

Once the playlist has been played, further playlist rules govern its destruction. If a large amount of information has accumulated un-played in temporary storage at the carrier, still other playlist rules remove redundancies, keep it up-to-date, and warn the subscriber of its greater length at playtime.

Subscribers can configure their preferences to send different kinds of information to different portable devices. For example, a subscriber might want stock market updates and summaries sent to the subscriber's cell phone voicemail as promptly as possible, while the full texts of stock market news stories are sent to the subscriber's OnStar™ device, to be listened to while driving home from work. Another subscriber might want national and local news sent to his/her OnStar™ device to enliven a lengthy commute, while sports and obituaries from his/her hometown newspaper are loaded onto his/her MP3 device for listening at greater leisure.

In yet another embodiment, a database module is used instead of a router for accepting a subscriber preference, distribution lists and data in at least one of structured and unstructured format from a data source of said subscriber. A first conversion means is provided as in the previous embodiment, but in this case it obtains any of the unstructured data from said database module, converts textual data to at least one of audio or visual data and stores the converted data in a multimedia database library. A multimedia database library is provided for storing converted data, placeholders including sentence templates, media segments, media advertisements, and media news. At least one and preferably a plurality of second conversion means for converting structured data to an associated one of at least audio, visual or video previously recorded is provided, typically as part of a play module. A distribution agent is provided for obtaining structured data and subscriber preference data from the data module, creating a data frame associated with each such data, obtaining unstructured data frames from the first conversion means or said database module (after data frame has been proceeded by first conversion means), storing such data, and preparing distribution lists of subscribers according to subscriber preference data, when no distribution list is provided by a data source. A distribution manager manages the distribution of subscriber data over at least one network to at least one of the second conversion means for converting data from said multimedia database library and any placeholders stored therein for structured data, for delivery to a subscriber for playback of converted audio and/or visual data.

In alternate embodiments, the play module and its local copy of the Multimedia Library can be internal to the system or reside externally on the subscriber receiver, servers hosted by service provider for the subscriber receiver, third-party servers, or other locations. Alternatively, the second conversion means may also be part of an externally hosted play module or form a part of the software residing on the aforementioned locations.

In a presently preferred implementation of the above-mentioned play module, the play module is designed to accept large amounts of data with associated distribution lists from upstream systems such as the one described herein or other upstream systems. The play module uses various playlist generation rules to organize data and create a pleasing and customized presentation. The playlist generation rules, described herein, apply to different levels of the presentation. As mention above, some rules determine how events are ordered and while others manage the frame to audio or visual conversion. The components of this embodiment of the play module include a playlist sequencing agent, or “Playlist Sequencer”, a “Presentation Item Composer”, a “Remediation Agent”, and a “Media Composer”. The play module also contains a local copy of the “Multimedia Library” including all segments, placeholders, audio and/or video news stories, any other visuals, and audio and/or visual ads. Another component of this embodiment of the play module is an Event Manager. Event Manager receives textual and audio-visual data from upstream systems (such as the on described herein or any other system) used to prepare a subscriber-specific media presentation. Another component of the presently implemented play module, subscriber request manager, or “Request Manager”, manages a subscriber session when a subscriber requests a media presentation from a presentation server through his/her distribution network. This includes, for example, accepting user identification from the presentation server, providing user identification to the other components of the play module to produce required media, and after receiving the subscriber's selection, instructing the presentation server which media files to download and play to the subscriber.

The invention can provide for interactivity. For example, subscribers can have the option of modifying their preferences on the fly, using interactive prompts through a cell phone or the like. Other advantages of the present invention will become apparent from a perusal of the following detailed description of a presently preferred embodiment taken in connection with the accompanying drawings.

### BRIEF DESCRIPTION OF THE DRAWINGS

FIG. 1 is a block diagram showing a high-level view of the system, with inputs and outputs shown from the point of view of the subscriber and the content providers;

FIG. 2 is a flowchart representation of a presently preferred embodiment of the invention;

FIG. 3 is a flowchart of the data flow within an embodiment of the conversion means of the present invention;

FIG. 4 is a schematic data representation of a subscriber record stored in a distribution agent in one embodiment of the present invention;

FIG. 5 is a schematic data representation of a delivery preference record stored for use by the distribution agent in a preferred embodiment of the present invention;

FIG. 6 is a schematic data representation of a content preference record stored for use by the distribution agent in a preferred embodiment of the present invention;

FIG. 7 is a schematic data representation of a structured news event record stored in for use by the distribution agent in a preferred embodiment of the present invention;

FIG. 8 is a schematic data representation of an unstructured news event record stored in the distribution agent of FIG. 2;

FIG. 9 is a schematic data representation of a subscriber profile record stored in the distribution agent in an embodiment of the present invention;

FIG. 10 is a schematic data representation of an advertisement record stored in the distribution agent in a preferred embodiment of the present invention;

FIG. 11 is a schematic data representation of a playlist preference record stored in a distribution agent in a preferred embodiment of the present invention;

FIG. 12 is a schematic data representation of a distribution list for routing an audio and/or visual version of a structured news event to public carrier voice mail, telematic systems, and their end subscribers;

FIG. 13 is a schematic data representation of a distribution list for routing an audio and/or visual version of an unstructured news event to public carrier voice mail, telemetry systems, and their end subscribers;

FIG. 14 is a diagram representing a sentence template for constructing sentences and their audio counterparts from FIGS. 7 and 8;

FIG. 15 is a schematic data representation of records for storage of sentence segments and variable phrases for use in sentence templates;

FIG. 16 is a schematic data representation of the rules for organizing presentation items by vertical content (e.g., sports, weather, financial), by publisher, by paragraph, sentences or clause;

FIG. 17 is a flowchart representation of one possible implementation of the invention described with respect to FIG. 2 using Enterprise Java Beans, Oracle Databases and XML data interchange; and

FIG. 18 is one possible logical model of the database tables for data from FIGS. 3-16 for the system shown in FIG. 2.

FIG. 19 is a high-level view of the system architecture of a presently preferred embodiment of the play module.

FIG. 20 is a is a schematic depicting the interactions in an embodiment between Request Manager, which is a component of the play module, and the presentation server.

FIG. 21 is a flow diagram depicting in an embodiment structured data processing by Presentation Item Composer and Media Composer, two components of an embodiment of the play module. The diagram depicts the flow both with and without the use of a 3^{rd} party text-to-media engine.

FIG. 22 is shows the organization of a presentation in an embodiment by showing the various levels and components of a presentation, along with the playlist generation rules implemented at those level and the components of the play module that implement those rules.

### DETAILED DESCRIPTION OF THE INVENTION

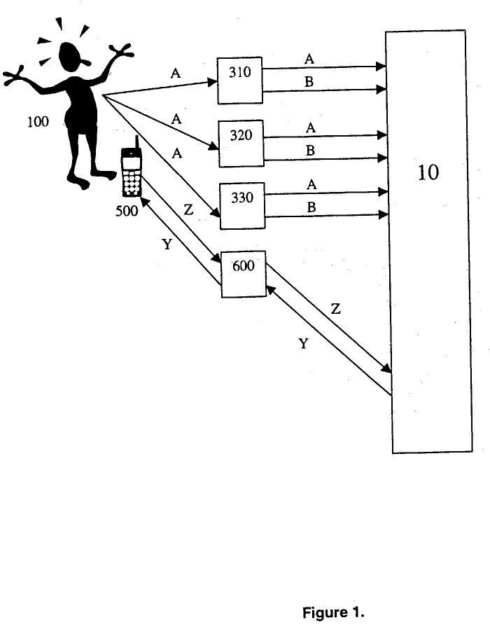

Referring to FIG. 1, a presently preferred embodiment of the invention is illustrated in conjunction with existing automated news delivery services that are provided to registered subscribers. The system 10 of the present invention relates a subscriber 100 through a communication device 500, such as a mobile phone or an OnStar™ device, connected to a carrier 600. Alternatively, device 500 can be a PC and 600 can be an entity hosting one or more servers streaming audio/video. Subscriber 100 provides user registration and preference information 100A to a data source 310, 320, and 330 that provides user registration information 100A and news content 310B, 320B and 330B to system 10. System provides audio and/or visual conversion of the news content 10Y to carrier 600 on command of subscriber by command signal 500Z/600Z through the carrier to system 10. News content is considered to be any information that may be of interest to a subscriber or information that is requested by a subscriber.

Typically, data sources 310, 320, and 330 provide news updates or other requested topical information over the Internet. Subscribers register directly with the services by providing preference information to one or more content providers, generally by means of a selection screen offered at the content providers website. When used with the present invention, the content provider provides subscriber-selected information to the present invention that is made available to subscribers who have selected audio and/or visual delivery as a preference. Content providers may also send news, in addition to subscriber selected news, as soon as such item is “published”. Once received in the present invention, the incoming textual content is converted to audio and/or visual format, utilizes the registration and preference information of the subscriber to assemble a customized audio and/or visual news program, and delivers that program to the subscriber's player device, when requested by the subscriber.

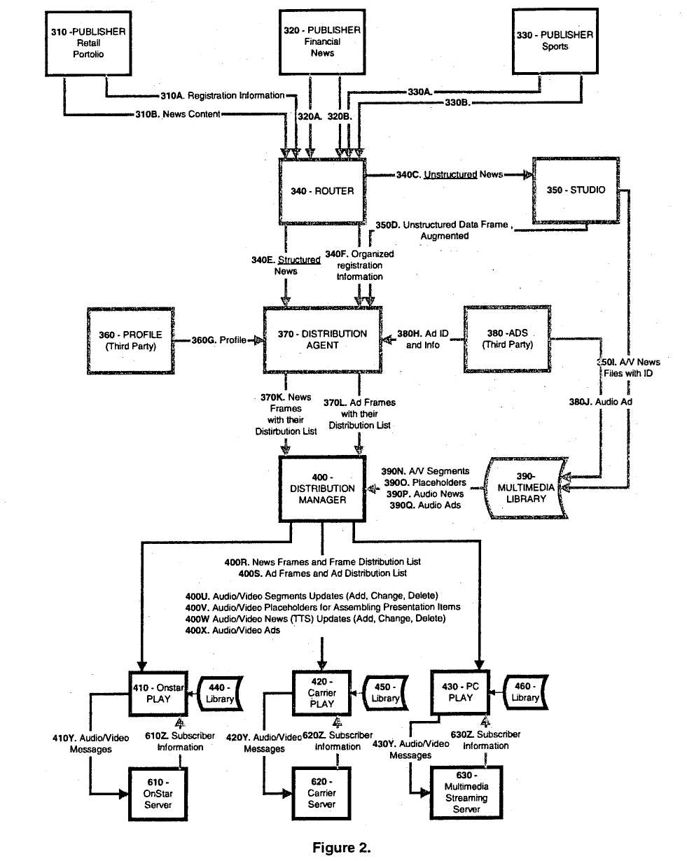

The architecture of system 10 according to a presently preferred embodiment of the invention is shown in FIG. 2. Data sources including on-line content providers such as publishers, content aggregators and other data sources integrate the systems of the present invention API into their existing alert or news delivery systems. Different versions of this API may be implemented for specific domains, such as a portfolio provider 310, financial news provider 320, sports provider 330, and the like. When a subscriber signs up to receive information from a data source, the subscriber has the option, for example, to request to receive audio and/or visual versions in addition to text or SMS messages. The subscriber typically registers with the data source through the source's web page or other means such as the post. Publishers 310, 320 and 330 are configured to communicate through system API and the present invention is capable of accepting data from the various data sources. In a first step of a presently preferred embodiment, the system receives a subscriber registration information 310A, 320A and/or 330A that has been gathered by the respective data sources. A data source passes information 310A, 320A and 330A, respectively, from the data source, for example, over the Internet or by direct connection to Router 340 within system 10 infrastructure.

Included in this information transmitted within 310A, 320A and 330A is subscriber registration information such as an ID number, the subscriber's name and contact information, mailing and e-mail address(es), wired and portable telephone numbers, and the like. It also includes a subscriber's preferences, such as content domains (e.g., portfolio, sports, weather, industry news), particular subjects (e.g., individual stocks, favorite sports teams, frequently-visited cities, topics of interest), optional thresholds (e.g., send an update if Compaq trades 3% above its opening price), optional organization preferences (e.g., instructions for generating the playlist), and delivery instructions (i.e., which information in which format should be sent to which device). Alternately, these delivery preferences can be sent directly to play module from presentation server or any other system on the distribution network used by the subscriber, for example, a wireless service provider's website.

In addition to registration information, data sources 310, 320 and 330 receive news content or events 310B, 320B and 330B from providers of data. Typically, the providers are online or Internet-based providers. Each event 310B, 320B and 330B is typically provided by the provider to a data source or publisher into a standard format for packaging. Once packaged, content 310B, 320B and 330B is delivered to system Router 340.

System Router 340 accepts various content 310B, 320B and 330B from the API in a standard packaged format. The format for structured data may be a frame consisting of a series of slot-value pairs, which are specific to the particular-domain. For example, a structured frame for stock price updates could include different slot names and different types of values from the frame for sports scores. Unstructured data can be in a similar frame, but would have one or more slot values that are free text fields of arbitrary length. Both types of frames carry the publisher identification, time of publication, domain, and the like of the publisher or data source.

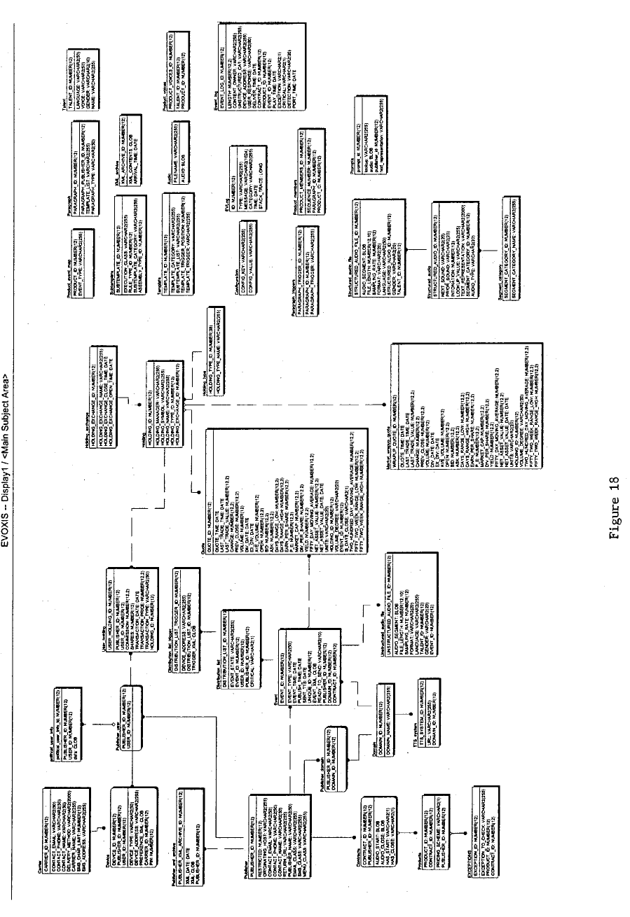

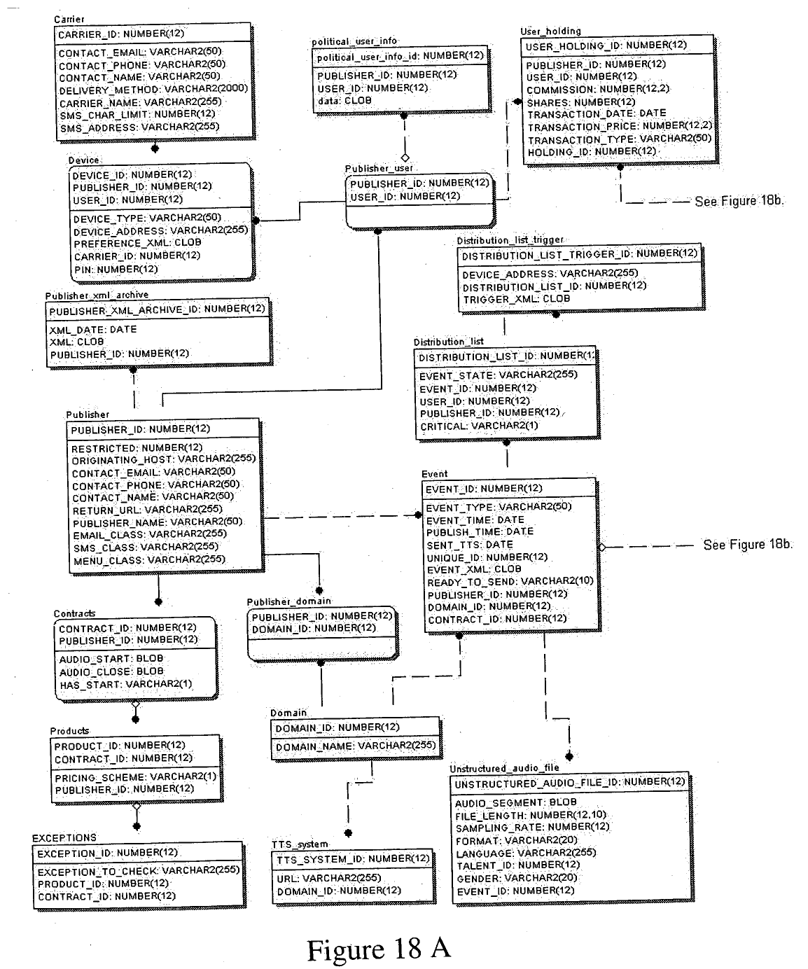

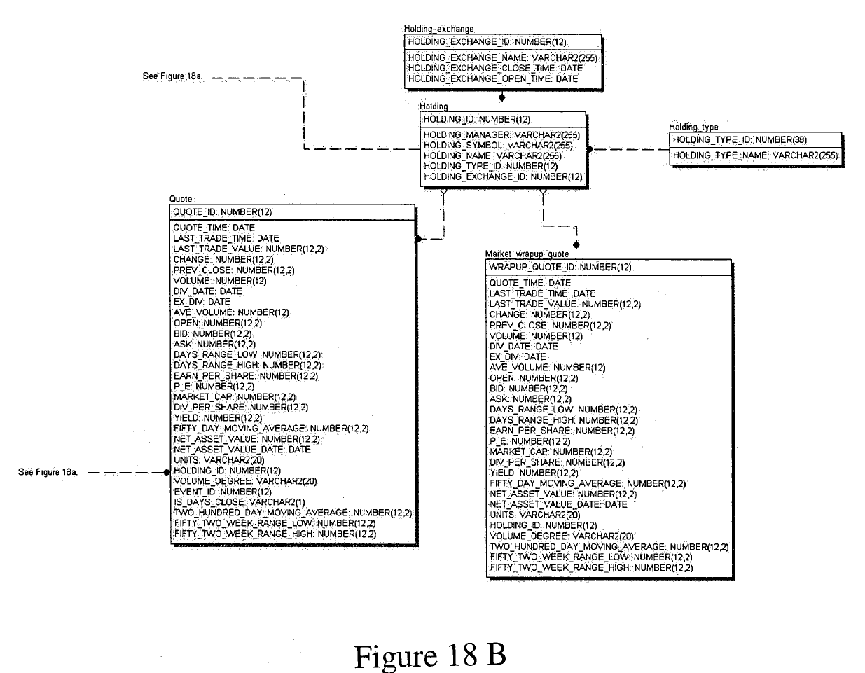

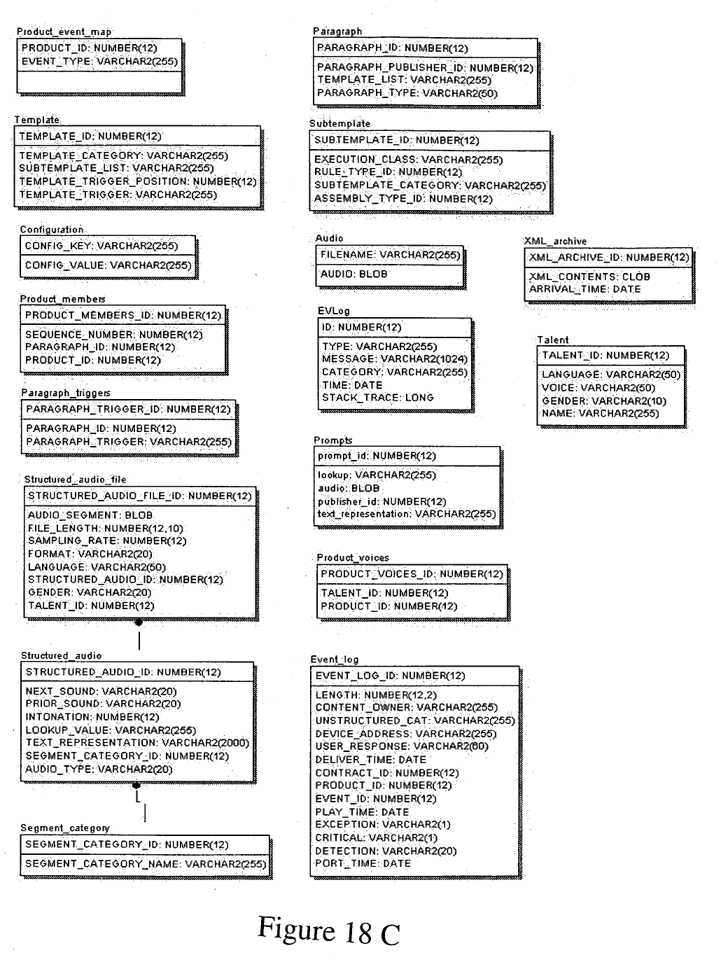

Upon receipt of information, Router 340 sorts and organizes subscriber registrations contained in data streams 310A, 320A and 330A and may remove any duplicates. If a subscriber has accounts with different data sources, there is an entry in the user database (see FIG. 18) corresponding to each data source. Each entry also specifies the device address for the subscriber receiver 500 (FIG. 1). For example, for a cell phone, the address can be the cell phone number. The play module, described herein below, is responsible for ensuring that the events from the various data sources are all organized and delivered to the specified device address.

Router 340 then passes organized subscriber registration data 340F to Distribution Agent 370. Router 340 organizes content 310B, 320B and 330B and distinguishes structured data from unstructured data. It routes structured data 340E to Distribution Agent 370 and unstructured data 340C to a conversion means 350, for example Studio, where it is converted to audio and/or video format. This can be achieved by voice/video synthesis software or human talent. Other visuals can be created and stored in the Multimedia Library at this time. Structured data 340E is data that is formulaic and (in most cases) consists primarily of numbers and/or named entities—for example, stock price updates, breaking sports scores, changes in airline schedules, or weather alerts. Unstructured data 340C is free text, for example, summaries or full articles. Router 340 routes structured 340E and unstructured data 340C to separate modules.

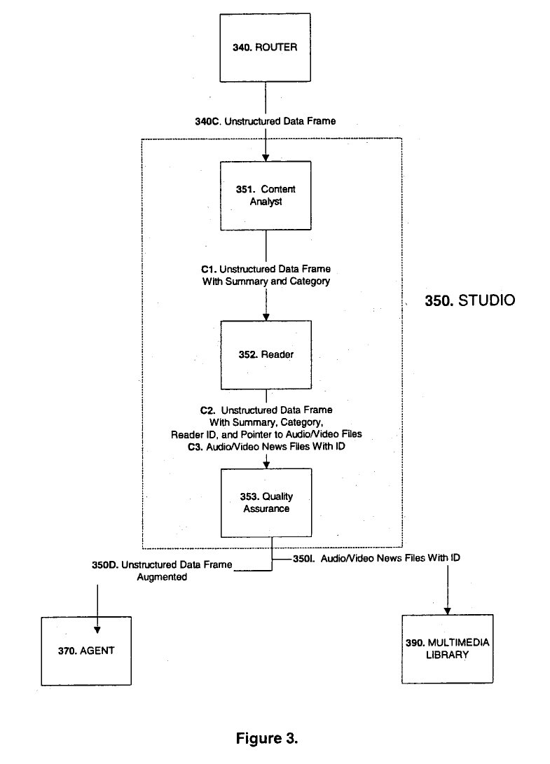

The first conversion means (e.g., Studio 350) receives unstructured data 340C (free text) from Router 340 where it is queued and routed through a series of steps before passing them on to Distribution Agent 370. For example, categorization information and a summary are preferably added, and the full article and the summary are read aloud to convert them to audio and/or video files. (See FIG. 3 for more information on the queue and these steps.) Additional visuals can also be created and stored at this time. An unstructured data frame 350D (340C with additional information) is routed to Distribution Agent 370 and the audio and/or visual files 350I are sent to a database (see FIG. 18) in a Multimedia Library 390.

Distribution Agent 370 performs several operations. These operations include:

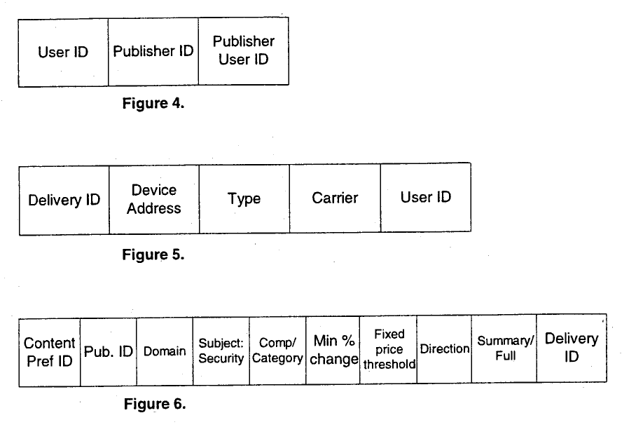

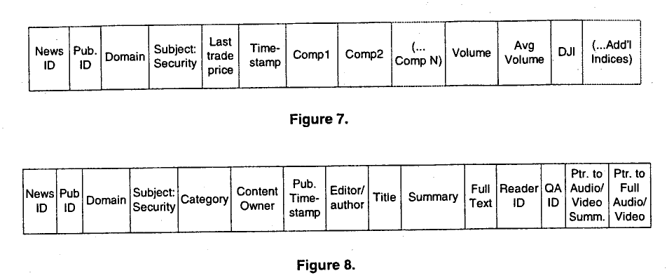

Storing subscriber registration information 340F received from Router 340 as a set of related records in linked database tables (FIG. 18): subscriber records (FIG. 4) are linked to delivery device records (FIG. 5), to playlist preference records (FIG. 11), and to content preference records (FIG. 6)

Storing news event frames (structured data frames) 340E received from Router 340 as records in a database table (FIG. 7)

Storing news event frames (unstructured data frames) 350D received from Studio 350 as records in a database table (FIG. 8)

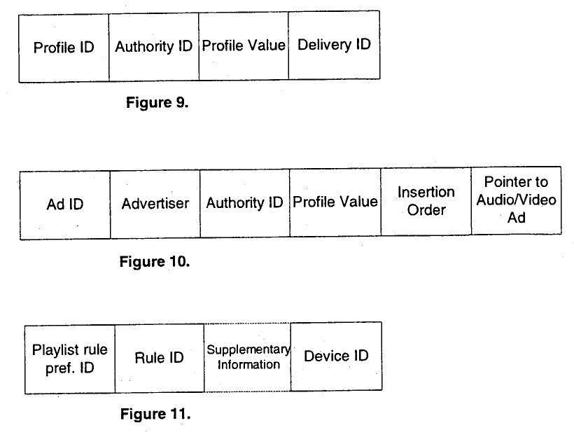

Storing subscriber profiles 360G received from profile 360 as records in a database (FIG. 9), linking them to device records (FIG. 5)

Storing advertisement information 380H received from Ads 380 as records (FIG. 10) to be compared with profile records (FIG. 9)

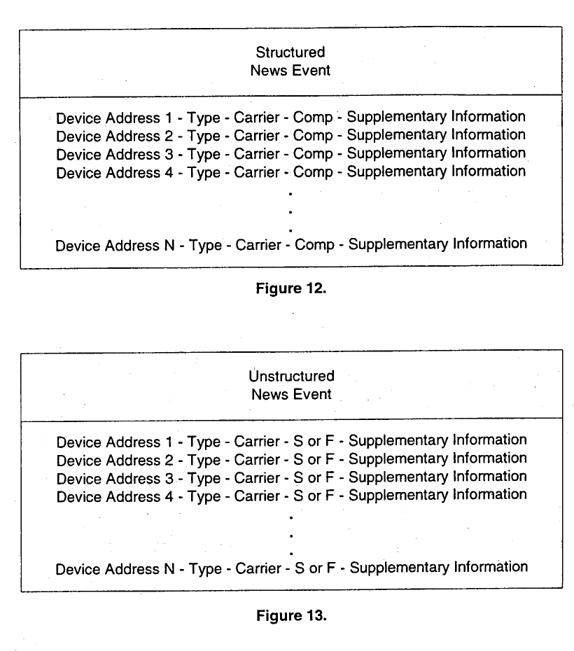

Creating distribution lists, if required, for news (FIGS. 12-13) and advertisements

Passing news event frames 370K and advertising frames 370L, with their distribution lists, to Distribution Manager 400

Playlist generation rules are rules for organizing data such as news and advertising material for one or more subscribers. These rules are stored in the play modules or agents described hereinafter. They include rules for the construction and destruction of a delivery, organization, advertisement insertion, and talent selections. There are default playlist generation rules defined for all subscribers. In one embodiment, a subscriber can customize these rules according to individual needs.

Profile 360, a third-party external profiling engine, generates profiles 360G and associates them with specific subscribers. In an alternate embodiment, the profiling functionality can be performed by system 10 from FIG. 1. Internal data may be used to generate the profiles, though the system shown in FIG. 2 does not do so. Profile 360 selects appropriate profiles based on independent information about a particular subscriber. Profiles may be of any type, such as demographic, geographic, psychographic or affinity group. Profile 360 sends the profiles 360G to Distribution Agent 370 associated with subscriber IDs. In a preferred embodiment, the subscriber ID is a combination of the Publisher ID and the user ID for that subscriber issued by the Publisher.

Ads 380 sends insertion orders for audio and/or visual advertisements 380H to Distribution Agent 370. The order indicates the profile of target subscribers for a particular advertisement (using, e.g., VALS or Claritas categories); or, for example, an associated sponsor (e.g., a Brokerage sponsorship message should be distributed with Brokerage content to the affinity group profiled as “Broker investors”). Ads 380 sends the actual audio and/or visual commercial messages 380J, with subscriber ID information, to the database library 390. Ads 380 can store the insertion order locally, or it may obtain the insertion order through an ad distribution network such as Doubleclick. Ads 380 may obtain the actual audio and/or visual advertisement locally, or it may obtain the audio and/or visual ad from an ad distribution network.

If a data source provides a distribution list for a news event, Distribution Agent 370 preferably validates it. If no distribution list is provided, Distribution Agent 370 preferably performs the following operations:

Compares an individual subscriber's content preferences against the domain and subject fields for data such as news events (for structured and unstructured data),

Performs calculations (for structured data). Alternately, some or all calculations may be performed in play module,

Compares the subscriber's profile against target profile information (on commercial messages), and

Prepares individual subscribers' playlist generation rules or information used by rules to be included in the distribution list only if Distribution Agent stores a subscriber's delivery preferences,

to create distribution lists. A distribution list indicates the set of devices to which a particular news event or commercial message should be delivered. Distribution Agent 370 passes structured and unstructured data 370K, advertisements 370L, with their associated distribution lists, to Distribution Manager 400. It should be noted that Distribution Agent 370 is not always responsible for building the distribution lists for every structured, unstructured news event or ad. This is the case for advertisements, but not for a structured or unstructured news event. For an unstructured or structured news event, Distribution Agent 370 builds distribution lists only if none are provided by the data sources 310, 320, or 330. There are four scenarios that can be considered. All or fewer than all can be implemented. For example:

a. A data source (e.g. 310) provides distribution lists along with every news event. Distribution Agent 370 validates the list, augments (only if required) each subscriber item in the distribution list with additional subscriber information used by downstream modules 400, 410, 420, or 430, and passes on the events with the augmented distribution lists to Distribution Manager 400.

b. A data source (e.g. 310) provides subscriber information in one transaction and Distribution Agent 370 stores this registration information in a database. In a later transaction, the same data source 310 sends a structured or unstructured news event with no attached distribution list. Distribution Agent 370, as described above, uses previously stored subscriber information to construct a distribution list for the news event and passes on the event with the attached distribution list downstream.

c. A data source (e.g. 310) provides subscriber information in one transaction and Agent 370 stores this registration information in a database. Later, a different data source, sends a structured or unstructured news event with no attached distribution list, as the latter data source has no information about subscribers belonging to 310. Distribution Agent 370 then assembles a distribution list for that news event with the help of the subscriber information provided by data source 310. For example, data source 310 may be Charles Schwab and the second data source may be Bloomberg News Service.

d. A data source (e.g.310) provides subscriber information in one transaction and Distribution Agent 370 stores this registration information in a database. A different data source provides data that is used to construct both the news event and the associated distribution list with the help of subscriber information provided earlier by data source 310. For example, data source 310 may be Charles Schwab providing subscriber preferences as to which stocks to track and when to send them a structured news event about price movement. The second data source may be Bloomberg providing stock quotes every 5 minutes for all publicly traded stocks. The system 10 continuously processes the quotes from the second data source to determine for each stock, which subscribers should now get a price movement event. It then composes the news event, builds the associated distribution list of all subscribers that need to be informed, and passes the event with the distribution list downstream to Distribution Manager 400.

Distribution Manager 400 divides distribution lists by distribution network, for example, telecommunication providers, wireless broadband or the like. For example, from one inclusive list, it may create separate lists for Verizon, AT&T, and other servers, as well as for individual player devices such as home PCs (which may have only one or two subscribers). Distribution Manager 400 also manages delivery of the audio and/or visual material 390N, 390O, 390P and 390Q from the Library 390 such that it is sent to the player devices before any placeholders or playlists that require that material are processed. In alternate embodiments, Distribution Manager is not responsible for delivery of audio and/or visual material 390N, 390O, 390P, and 390Q from Library 390 to local copies attached to play module. Said delivery may be performed using other means such as manual or automatic software updates and/or manual or automatic synchronization of databases.

Multimedia Library 390 is a database (or table within a database, e.g. FIG. 18) that contains:

Human-recorded audio and/or video segments for structured news;

Placeholders (including sentence templates) for constructing complete presentations out of human-recorded audio and/or video segments;

Human-recorded full texts and summaries, delivered to Multimedia Library 390 from Studio 350;

Additional visuals illustrative of structured or unstructured text; and

Audio and/or visual advertisements and sponsorship messages, delivered to Library 390 from Ads 380.

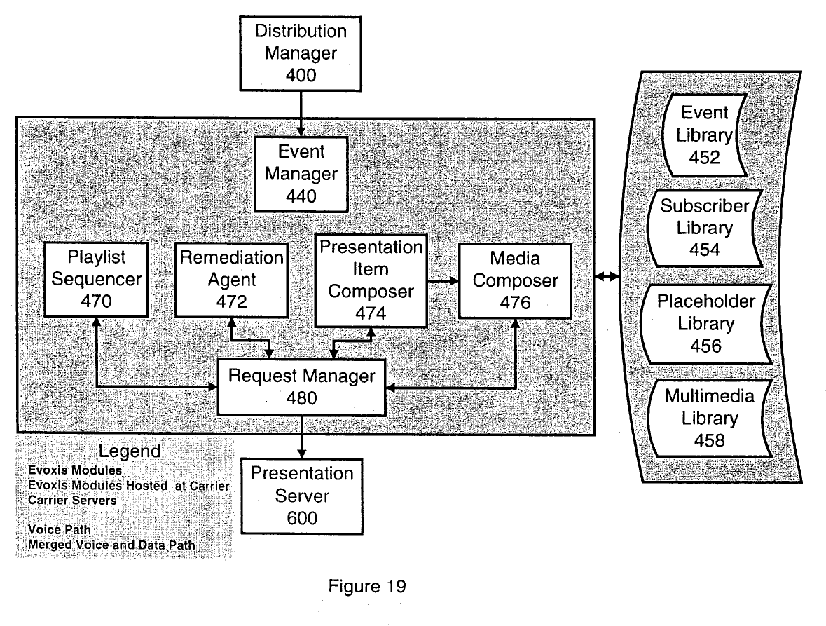

All of the audio and/or visual files from Library 390; that is—segments 390N, placeholders 390O, audio news articles (full text and/or summary versions) 390P, and advertisements 390Q—are provided to Distribution Manager 400. Distribution Manager 400 delivers the structured and unstructured data 400R and advertisements 400S, with the associated distribution network-specific distribution lists, to Play modules 410, 420, and 430. One embodiment of the play module is included as FIGS. 19-22, which is also discussed below. The distribution lists may also include subscriber-specific information used by playlist generation rules. Parameters used by playlist rules and the rules themselves can be included as part of subscriber information in a distribution list. In addition, these parameters and/or the rules can be stored in the subscriber database maintained by Distribution Agent 370 and/or Play modules 410, 420, and 430.

Play modules 410, 420, and 430 work with play devices at the receiving end for the subscriber, whether the device is a voicemail server 620 in Poughkeepsie, a server streaming audio and/or visuals 630 to subscribers' home PCs, or a subscriber's home PC itself, for example. Play modules 410, 420, and 430 receive data such as news events 400R and commercial messages 400S, with their distribution network-specific distribution lists, and with embedded subscriber information used by playlist generation rules from Distribution Manager 400. In one embodiment, Play modules also receive the full set of audio and/or visuals 400U and placeholder files 400V from Distribution Manager 400. In an alternate embodiment, local copies of Library 390 receive audio for structured data (part of 400U) and placeholder files 400V through means such as database synchronization, as mentioned above. Play modules 410, 420, and 430 manage the audio and/or visual and placeholder files libraries 440, 450 and 460, respectively, as local copies of Library 390. Play modules 410, 420, and 430 can be resident on a playback device, on a distribution network location, or third party server, or other locations.

In an embodiment, a sentence template, one type of placeholder, 400V, is essentially a sentence structure that can be used to communicate a portion of the information contained in a structured data frame. It is associated with a structured news frame and a subscriber's preference tag. It consists of a set of pointers to audio and/or visual segments in a Local Library, some of which are fixed, and some variable, to be filled in on the basis of frame information. For example, a subscriber may have chosen a threshold of “3% above the opening price” for news about Compaq Computer. A news event arrives containing the information that Compaq is now at $1.04, together with a great deal of comparison information, including the fact that Compaq opened in the morning at $1.00. Since the news frame meets the subscriber's selection criteria ($1.04 is more than 3% above $1.00), Distribution Agent 370 places the subscriber's device address on the distribution list for the news event, together with a tag indicating that “opening price” was the factor used in selection for that particular subscriber. (Note: this processing is not necessary in scenario (a) above on Page 15.) Play module 410, 420, or 430, if the subscriber's device address is on the distribution list to receive such news, then selects a sentence template (sentence structure) that explicitly compares the current price to a lower opening price. A choice of several sentence templates is available for each individual preference value, to build in variety. The sentence template is completed using the appropriate specific information in the structured data frame. In the current example, the audio and/or video segments 4 percent and 1 dollar are inserted into a sentence template to complete an audio and/or video sentence: for example, This represents a 4 percent increase over today's opening price of 1 dollar.

When a subscriber requests the playlist over voicemail 620, OnStar™ 610, or multimedia streaming server 630, Play module 410, 420, or 430 dynamically constructs the playlist, selects the placeholders, calls the appropriate segments, and plays the composed audio and/or visual events for the subscriber directly or with the help of presentation servers. (The one exception is delivery by MP3 player; in this case the delivery is constructed in advance and downloaded as a single file to the player device.) A sentence template ultimately resolves to pointers to fixed audio and/or video segments from Library 390, interspersed with pointers whose values are calculated on the basis of one or more data points in the structured news event, then looked up in the library. Within play modules 410, 420, or 430:

The distribution lists 400R and 400S determine which particular news events and commercial messages the subscriber will receive;

The playlist generation rules order the messages by domain (e.g., portfolio) and by subject (e.g., Compaq Computer news);

The playlist generation rules also remove redundant, conflicting, or obsolete messages;

The playlist generation rules consolidate events about a related topic into a single concise event;

The playlist generation rules select appropriate placeholders for the messages to be delivered; within a subject, the rules ensure that there is a topic sentence template, followed where required by other new information followed by background information (paragraph structure is preferably not subscriber-configurable); and

The playlist generation rules vary sentence structures and voices in a pleasing way.

FIGS. 19-22 show a presently preferred implementation of a play module, the levels of organization of a presentation and the playlist generation rules implemented at those levels, and a flow diagram related to the processing of structured data by the play module.

In one embodiment, once the subscriber has listened to a particular playlist, s/he has the option of saving it on the Local Library 440, 450, or 460 attached to the play module. Since the playlist is managed as a set of media segment IDs by the play module, it does not take up any of the (generally limited) voicemail minutes that the subscriber has available. Storing the playlist as a set of media segment IDs instead of an audio file also significantly reduces storage space consumption on the Local Library. If the playlist is stored as a set of media segment IDs, audio file in the format, supported by the subscriber receiving means, can be constructed by using pointers to audio segments, in the supported format, corresponding to the media segment IDs. In this case, the subscriber is saving the presentation item instead of the event itself.

In an alternate embodiment, Play module stores the status of an event with respect to each subscriber on its distribution list. For example, for a subscriber, the event can have the status <Unread>, <Read>, <Skipped>, and <Saved>. Subscribers with the status <Read> may be removed from the distribution list by the system, if they do not wish to retrieve this event again. Subscribers with status <Saved> are retained as members of the distribution list until the event itself is removed. In this embodiment, when a subscriber retrieves a saved event, the playlist is regenerated to be as relevant as possible at the time of retrieval. Hence, it may not sound exactly the same as the first time the subscriber retrieved this event. The subscriber is saving the event data, not the playlist or the presentation item itself.

FIG. 3 shows the data flow within Studio 350 where unstructured text is converted to audio and/or visuals. The Router 340 passes unstructured data frames into Studio 350, which is essentially a complete audio and/or video studio. The frames are routed through the following steps:

First, a content analyst 351 skims the article and creates a summary, if a summary has not been provided. Content analyst 351 also chooses one or more subjects and categories for the article from a fixed inventory of subjects and categories. In the portfolio domain, a subject is generally the names of one or more securities (e.g., Compaq, IBM); categories include, e.g., management changes, insider trading, analyst downgrades/upgrades, earnings warnings, etc. Content analyst 351 delivers the story with its summary and category(s) C1 to a reader 352. If additional visuals are required, the content analyst creates them at this time.

The reader 352 reads the summary and the story separately into a microphone in front of a camera, and records digital audio and/or video files for each. He or she adds to the unstructured data frame a reader ID and pointers to the two audio and the two video files. The reader passes the augmented data frame C2 and the multimedia news files with ID tags C3 to Quality Assurance (QA) 353.

Quality Assurance 353 reviews the summary and category(s), and audio and/or visual files after the recording is performed, returning the frame C2 and files C3 to the content analyst 351 or the reader 352, as necessary, if there are errors. If there are no errors, QA 353 passes the augmented data frame 350D to the Distribution Agent 370 and the audio and/or visual files 350I to Library 390.

FIGS. 4-16 provide simplified illustrations of the database structure used for routing news in the “personal portfolio” domain. FIG. 18 is a more detailed logical model with cross-referencing between tables. News in other domains (sports scores, airline schedules, weather, etc.) is handled in similar fashion to portfolio news data, although the number of fields in a record (especially for the records in FIGS. 6-8) and the labels for those fields will vary.

FIG. 4 shows a record structure for subscriber records, consisting of a unique subscriber ID number (unique with respect to the data source or publisher), a data source or publisher the subscriber is registered with, and the publisher's ID number for that subscriber. The subscriber ID number may be the same as the publisher's ID number for the subscriber. Each subscriber record also contains contact information and domain-specific information (for example, subscriber's stock portfolio) used to build structured audio and/or visual events. There is preferably a separate subscriber record in the table for each data source or publisher the subscriber has registered with.

FIG. 5 shows a record structure for subscriber playback devices. These records consist of a unique device ID number, a device address (email address, cell phone number, etc.); a type field, indicating the type of device (PC, MP3 player, cell phone, voicemail, etc.); a distribution network field (Verizon®, AT&T®, etc.); and a subscriber ID pointing back to a subscriber record (FIG. 4).

FIG. 6 displays a record structure for subscriber content preferences. The content preference table includes all the content preferences registered by end subscribers of the system. Each record includes a plurality of fields including: a unique ID number; a publisher ID; a domain (portfolio, sports, etc.); a subject (in the portfolio domain, this will be a security selected by the subscriber); a comparison field, indicating the comparison of interest to the subscriber (“comparison” indicates a baseline parameter such as ask, bid, today's opening price, yesterday's closing price, 50-day moving average, etc.; “category” indicates a type of news such as management change, insider trading, analyst downgrade or upgrade, earnings warning, etc.); a minimum percent change field, indicating the percent the security's current price must move above or below the selected parameter in order to satisfy the preference; alternatively, a fixed amount field, indicating a price that the security's current price must move above or below in order to satisfy the preference; a direction field, indicating whether the threshold is for upward or downward movement; and a field indicating a preference for a summary of unstructured text or for the full text. Preferably, the minimum percent change, fixed price threshold, and direction fields are used only when the subscriber has selected a “comparison” rather than a “category” —i.e., they are used with structured rather than unstructured news events. Also, the minimum percent change and fixed price threshold are mutually exclusive—one or the other may have a value, but not both. The summary vs. full field is used only when the subscriber has selected a “category” rather than a “comparison”—i.e., they are used with unstructured rather than structured text.

FIG. 7 shows an abbreviated version of a record structure for an incoming news event. There is one record for each news event. For example, in the portfolio example, for each movement of a given stock price, there is a record. The record includes a plurality of fields including: a unique event ID; a publisher ID; a domain (e.g., portfolio); a subject (security name); the last trade price (i.e., the price to which the stock has most recently moved); one or more timestamps (indicating last trade time, publication time, or both); a large number of possible baselines against which to compare the current price (ask bid, today's opening price, yesterday's closing price, 50-day moving average, etc., represented here by Comp1, Comp2, . . . CompN); last volume (the number of shares traded); average volume; and a set of standard stock market metrics (e.g., the Dow Jones Industrial Average, the Standard and Poor Index, etc.).

When a structured news event (FIG. 7) is received by Distribution Agent 370, the publisher ID of that data event is looked up in the Preference table (FIG. 6), and all preferences involving that publisher are selected. For each preference involving that publisher, the subject, e.g. the security value, is compared, narrowing the set of matching preference records still further. Next, the selected comparison datum for each matching preference record is identified, and a calculation is made to determine whether that parameter has crossed the subscriber's preference threshold (by the specified percentage or beyond the specified fixed-price threshold, in the specified direction). For those preference records in which this criterion is met, Distribution Agent 370 looks up the delivery ID in the device table, and appends the device address, type, and carrier, together with the subscriber's selected comparison field from the content preference record, to a distribution list associated with the particular news event (FIG. 12), unless a distribution list is already provided by the data source.

FIG. 8 shows a record structure for an incoming unstructured news event. It contains the following fielded data: a unique event ID; publisher ID; domain (e.g., portfolio); subject (in the portfolio domain, this will be a security); category (e.g., management change, insider trading, analyst downgrade or upgrade, earnings warning); content owner (since the story may be copyrighted by the New York Times® even though it is distributed by Yahoo®); publication date and time; and editor or author. It also contains three free-text fields of arbitrary length, for the title, summary, and full text of the article. Finally, it contains the IDs of the reader who recorded the audio and/or video files and Quality Assurance analyst who cleared them, and pointers to the audio and video versions of the summary and the full text, and to any additional visuals

When an unstructured news event (FIG. 8) is received by the Distribution Agent 370 (FIG. 2), the publisher ID of the data event is looked up in the preference table (FIG. 6), and all preferences involving that publisher are selected. For each preference involving that publisher, the subject, e.g. the security value, is compared, narrowing the set of matching preference records still further. For each such preference, the category field in the preference record is compared with the category field in the news event. For those preference records where subject and category are a match, Distribution Agent looks up the delivery ID in the device table, and appends the device address, type, and distribution network, together with the subscriber's selection of summary or full text from the content preference record, to a distribution list associated with the particular news event (FIG. 13), unless a distribution list is already provided by the data source.

FIG. 9 shows a record structure for a subscriber profile, as constructed by third-party profiling software. The system may contain one, several, or no profiles for a given subscriber, depending on how many profiling “authorities” (e.g., VALS, Claritas, Nielson, particular publishers) have information about that particular subscriber. The record consists of a profile ID, an authority ID, a profile value, and a device address. Profiles behave very much like subscriber preferences within the system 10, with advertisements (FIG. 10) functioning as the associated “news events”.

FIG. 10 shows a record structure for an audio and/or visual advertisement. It consists of an advertisement ID, an advertiser, an authority ID, a profile value, a code for insertion order, and a pointer to the audio and/or visual advertisement, which is stored in the Library 390.

When an advertising record, see FIG. 10, is sent to system 10, its profile value field is compared with the profile value field in each profile record (see FIG. 9). For those profile records where the value is a match, Distribution Agent 370 looks up the delivery ID in the playback device table, and appends the device address, type, and distribution network to a distribution list associated with the particular advertisement. Advertisement records are sent to the appropriate device addresses when they are input to the system and the appropriate profile matches have been made.

FIG. 11 shows a record structure for subscriber playlist preferences. The options offered to the subscriber correspond to particular rules or constellations of rules, and are translated into records in this table. Each record consists of a unique preference ID, a rule ID, fields for optional supplementary information that the rule may require, and a device ID pointing back to the device table. Playlist generation rule preferences are accepted by the appropriate play modules when the subscriber sets up preferences, or changes his/her preference configuration. These preferences may be sent by the Distribution Agent or input by a subscriber from a website. Some of these preferences may also be embedded in the subscriber records in a distribution list associated with a structured or unstructured news event.

Referring to FIG. 12, a distribution list for a structured news event is illustrated. The news event is itself a record structure similar to that shown in reference to FIG. 7. The distribution data consists of a list of device IDs of the devices to which the news should be routed, along with type and distribution network information; and subscriber specific information used by playlist generation rules or the playlist generation rules themselves; all of this information was collected from the delivery records shown in FIG. 5. Each entry on the distribution list is associated with a Comp (comparison) field drawn from the content preference record (FIG. 6). To continue with the portfolio example, this allows the system to keep track of the fact that the subscriber of device 9400 was interested in percentage increase over the opening price, while the subscriber of device 9412 was interested in percentage increase over yesterday's close, etc.

In FIG. 13, a distribution list for an unstructured news event is shown. The news event or advertisement is itself a record structure similar to that shown in FIG. 8. The distribution data consists of a list of device IDs of the devices to which the news should be routed, along with type and distribution network information, and subscriber specific information used by playlist generation rules or the playlist generation rules themselves; all of this information was collected from the delivery records shown in FIG. 5. Each entry on the distribution list is associated with a selection of S (summary) or F (full text), indicating the subscriber's preference as to which to play.

Distribution lists for advertisements (not shown) are similar to the distribution lists shown in FIG. 12 and FIG. 13, except that the address, type, and distribution network information is not associated with any additional fields. This is because advertisements are selected as whole entities, with no subscriber-defined variables involved. However, there may be variables set by other entities such as data source, distribution network, and Evoxis.

With respect to FIGS. 4 through 13, examples of XML data representations are set forth below. These Document Type Definitions (DTDs) illustrate one way to communicate data from FIGS. 4 through 13 between various modules of System 10.

User Data:

A DTD for sending subscriber contact information and preferences from Retail Portfolio Publisher 310 to Router 340:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

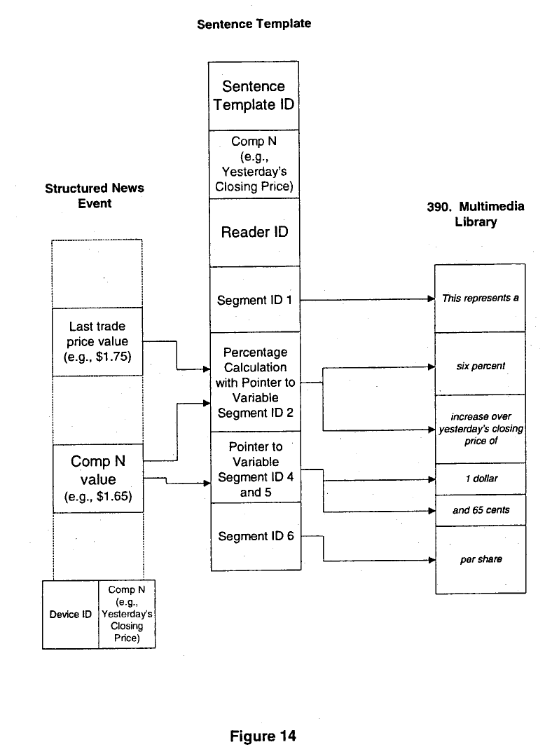

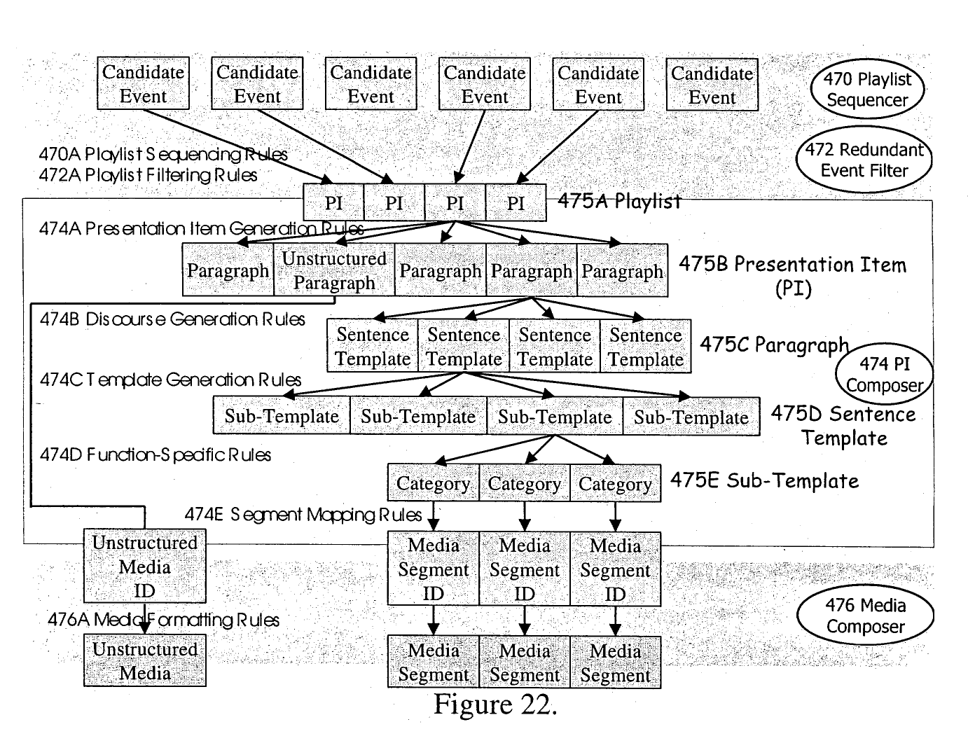

FIG. 14 shows, for a retail brokerage application, one type of a placeholder, a template for constructing a sentence (“sentence template”) and its audio or video counterparts from a structured news event like the one in FIG. 7, together with distribution data as shown in FIG. 12. Each sentence template has a sentence template ID that is preferably an integer and is used to index the sentence template in the database. The specific sentence template is chosen in the Play modules 410, 420, 430, on the basis of the Comp (comparison) field associated with the particular device ID/address to which the news event has been sent. (For example, if the value of CompN for a given destination device is yesterday's closing price, then one of the CompN sentence templates, all of which instantiate comparisons with yesterday's closing price, will be selected.) The sentence template ultimately resolves (through sub-templates and categories in FIG. 22) to pointers to fixed audio or video segments from Library 390, interspersed with pointers whose values are calculated on the basis of one or more data points in the structured news event, then looked up in the library. In the example shown in FIG. 14, the first segment (This represents a) comes directly from the library. The second segment is selected by calculating the percentage increase of the last trade price over the specified comparison price (here, yesterday's closing price), rounding the result, and selecting the corresponding audio or video segment from the library (six percent). The third segment (increase over yesterday's closing price of) is selected because the current price is greater than the comparison price. The fourth and fifth segments are selected on the basis of the value of the comparison price, which is looked up in the library (the segments one dollar and sixty-five cents are selected separately). The sixth segment (per share) comes directly from the library. The set of segments selected by the sentence template, when played in order, constitute one complete audio or video sentence. All segments used in a single sentence template must have the same reader ID. Variable segments must match sentence template constraints on category and intonation contour (e.g., follow-on, end of sentence, or contrast intonation).

Again, note that in an alternate embodiment, the system could generate text by using the sentence templates to organize the text fields of the segments in the database, rather than to organize audio files. The text could then be delivered directly to a subscriber, for example as email, or could be converted to audio by a text-to-speech engine.

In general, a sentence template specifies how to construct a cogent sentence customized for a subscriber based on structured data. The sentence templates may or may not be domain-dependent and have rules that specify how to construct a cogent sentence from the structured data. At a higher level, a sentence template is just one type of placeholders used in this system (see FIG. 22). While a sentence template helps construct a sentence, other placeholders apply to presentation items, paragraphs, and categories. These placeholders represent a concise and easy-to-maintain representation of knowledge on preparing a subscriber-specific presentation using structured and/or unstructured data.

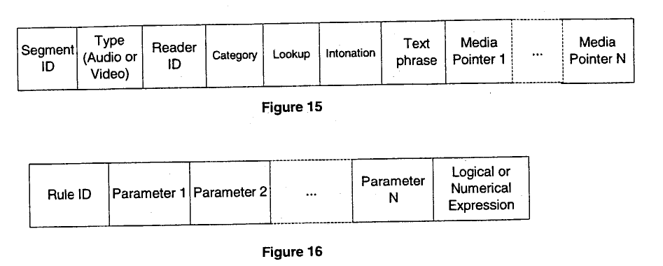

Referring to FIG. 15, a record structure for the storage of audio or video sentence segments and variable phrases is illustrated. Each record has a segment ID (also referred to as media segment ID), and can be selected using a pointer to the segment ID—this is the method used for the fixed phrases in a sentence template. The record also includes a reader ID and a type indicating audio or video. (A sentence template can only select segments that have the same reader ID and the same type.) Next, it contains the text or numerical phrase that this record converts to audio or video—for example, “65 cents”. This field is used both for the convenience of those maintaining the database, and also in cases where the system is used to generate text rather than, or in addition to, audio or video. Next come the category and the lookup value, which are used in system lookup of variable information. For example, if the segment to be voiced is sixty-five cents, the correct audio or video segment can be found by selecting the record with category “cents” and lookup value “65”. The next field contains an intonation code, so that the system can choose the correct intonation contour for a particular position in a sentence template. (For example, in a sentence like The stock rose $1.86 to $2.94 per share, eighty-six cents has follow-on intonation, while ninety-four cents has contrast intonation—ninety-FOUR cents. Most variable segments must be recorded multiple times to cover various intonation contours.) Finally, the record contains pointers to the appropriate audio or video segments in one or more formats e.g. WAV, MP3, MPEG.

It should be noted that there is no table equivalent to that in FIG. 15 for the audio and video versions of full news stories, summaries, or advertisements. The unstructured news event or advertising record distributed in accordance with the distribution list already contains the audio and/or visual pointers required to convert those records to voice or visuals in the appropriate audio/video formats.

In FIG. 16, a record structure for playlist generation rules for organizing presentation items by vertical content (e.g., sports, weather, financial), paragraph, sentences, and clauses, is shown. Each rule consists of an ID number, one or more parameters used by the rule, and a logical expression to filter a list of events or a numerical expression to sort a list of events. Some playlist generation rules can be selected by subscribers, while others are defaults, selected by distribution network, publisher, or other entities, or are non-configurable. These rules organize the news and manage the frame-to-audio conversion. In a preferred embodiment the system provides:

Subscriber Configurable

Order information by type/length (e.g., updates first, then summaries, then full texts);

Order information by publisher (e.g., Charles Schwab before T. D. Waterhouse);

Order information by domain (e.g., portfolio first, then weather, then sports); and

Order information by topic within a type, publisher, or domain (e.g., within Charles Schwab, order CPQ before IBM; within sports, order the Pirates before the Mets).

Non-subscriber Configurable

Select placeholders for structured data frames;

Organize the placeholders in such a way as to assemble coherent paragraphs (e.g., topic sentence, then new information, then background information); and

Insert sponsorship messages and/or advertisements at appropriate places.

In this preferred embodiment, while a subscriber can organize news by type, publisher, or domain, the playlist rules make sure that all information from a single publisher or on a single domain is delivered consecutively given that organization structure.

In alternate embodiments, other parameters or criteria may be used to order events. For example, a subscriber may want all events, irrespective of domain, to be sorted in last-in-first-out (LIFO) basis. A subscriber receiving updates about his/her holdings may receive updates ordered by value of his/her holdings. A salesperson receiving updates about customers may get information about customers, he/she has identified as critical, before information about other customers. The system supports the creation and execution of rules with arbitrary logic to meet the needs of subscribers.

Once the playlist rules have selected a set of placeholders, the placeholders in turn select audio and/or video segments from the local copy of the Multimedia Library to assemble coherent sentences. As the playlist is assembled, complete audio and/or video files and discrete audio and/or video segments are played in order to output an organized, customized, natural-sounding presentation tailored to the individual listener.

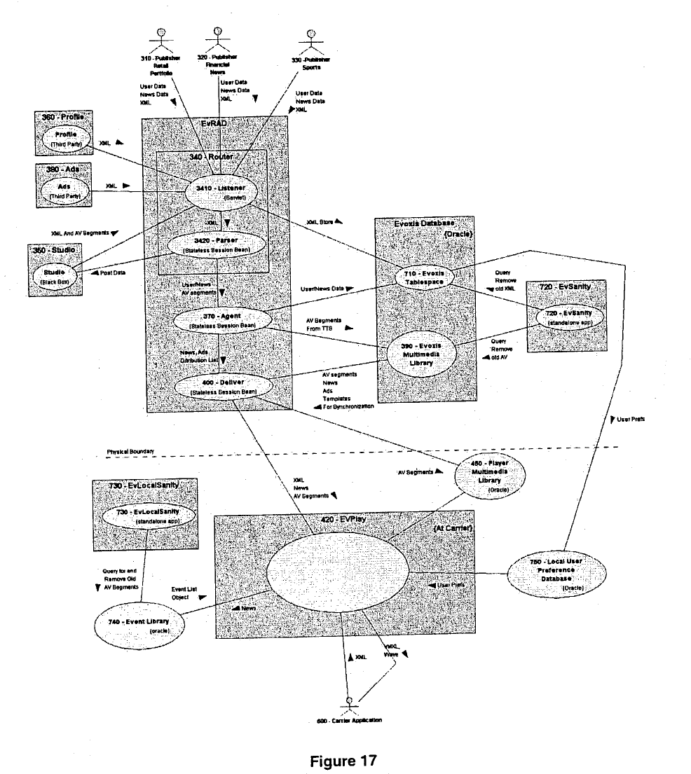

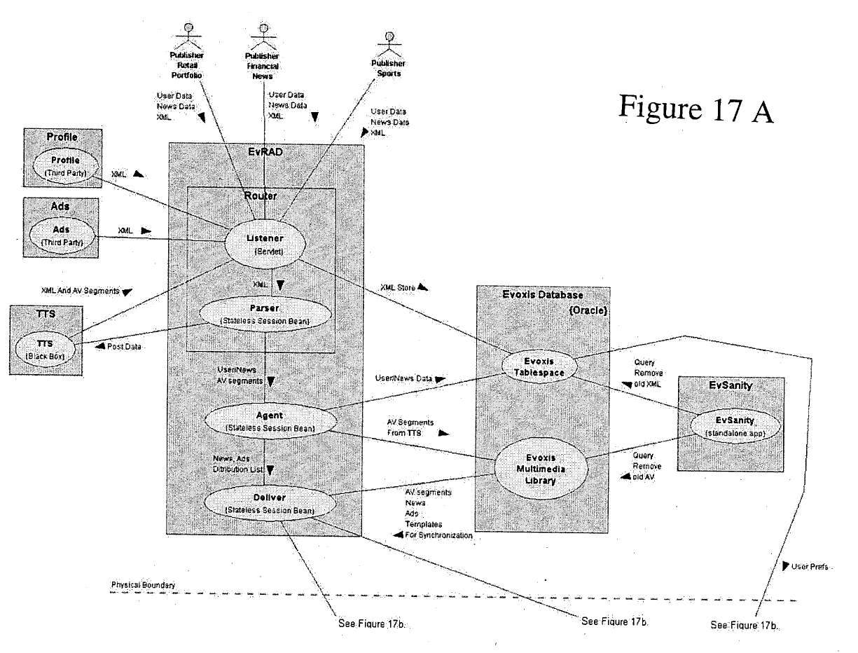

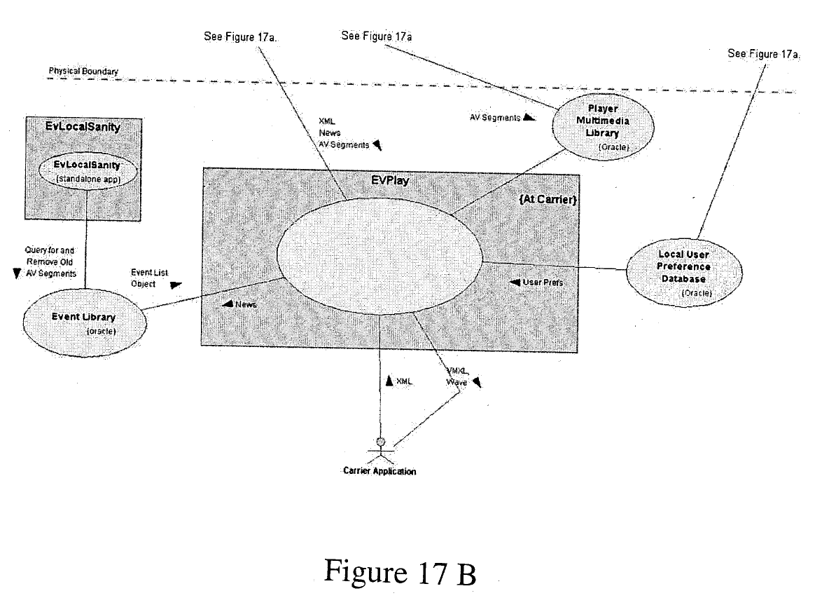

FIG. 17 shows one possible implementation of the system from FIG. 2 using Enterprise Java Beans and Oracle databases. In addition to the modules shown in FIG. 2, Tablespace 710 is the repository of subscriber information and incoming news events. EvSanity 720 is a stand-alone application that removes obsolete items from databases 710 and 390. It also monitors the XML data sent from data sources 310, 320, and 330 to ensure that Router 340 successfully processes them all. Router comprises modules Listener 3410 and Parser 3420. Listener 3410 receives data from the data sources and Parser 3420 converts the incoming XML data to Enterprise Java Beans and saves them to Tablespace 710. There are several modules that assist Play modules. FIG. 17 shows these components for Play module 420 from FIG. 2. Local User Preference Database 750 preferably stores delivery preferences for subscribers, Event Library 740 temporarily stores incoming data frames from Deliver 400, and EvLocalSanity 730, just like EvSanity 720, removes obsolete data items from databases 450 and 750. Data items corresponding to a data frame are obsolete when either all subscribers on the data frame's distribution list have heard the message or the maximum time an event is stored for playback has lapsed.

FIG. 18 shows one possible database implementation for the system. There are tables for subscribers, their preferences, data sources, events, and structured and unstructured audio.

FIG. 19 shows a high-level view of the system architecture of a presently preferred implementation of a play module, which is depicted in FIG. 2 as either 410, 420, or 430. In this description the play module is either the previously described secondary conversion means or contains the secondary conversion means. To avoid confusion, only the term “play module” shall be used. In this embodiment, the system is designed to accept large amounts of data with associated distribution lists from upstream systems as described herein, or other upstream systems. The play module is therefore able to function as part of the system described herein, or independent from the system described herein as it can be adapted to accept large amounts of data with associated distribution lists from any upstream system. The play module is able to serve a large number of concurrent sessions with subscribers who are retrieving their customized media presentation.

The play module comprises an Event Manager 440, a sequencing agent or Playlist Sequencer 470, a Remediation Agent 472, a Presentation Item Composer 474, a Media Composer 476. Also included is a Local Library 450 that is attached to the play module. Local Library comprises an “Event Library” 452, “Subscriber Library” 454, “Placeholder Library” 456, and “Multimedia Library” 458. The Request Manager 480 is a component of the play module that manages a subscriber session upon the subscriber's request. Each component will be described in detail below.

In the following description of this embodiment of a play module, the upstream system is the one described herein, note however, that other upstream systems may be used. Distribution manager 400 is upstream from the system and delivers textual and audio-visual data to Event Manager 440 in the form of XML files, for which DTD files are known to the upstream system. It is important to note that the only implementation work required for any upstream system is to identify the point of integration, generate a text file with XML tags in accordance with DTDs, and transmit them to the play module system. Since Event Manager 440 is designed to accept textual and audio-visual data, any upstream system has the option to provide the play module with text data and the play module produces high-quality media (e.g. audio file) using the incoming data. Alternatively, the upstream system may use a conversion means of its choice and supply play module with textual data and associated media. Yet another option for an upstream system is to provide textual data and access information for a preferred conversion means. The play module uses the preferred conversion means while producing media using the incoming data.

For example, consider a news update sent from the system in FIG. 2 to Event Manager 440. A news update consists of an essay-type news article from a content provider followed by a subscriber-specific piece that lays out the impact of the news item on an individual subscriber. To ensure production of a high-quality media presentation and yet service a large number of concurrent subscriber sessions, human voice talent in an operation center, represented by Studio 350 in FIG. 2, records the news article and the media file is sent to Event Manager 440 along with the associated text and distribution list. In this example, the subscriber-specific media is not provided by the system from FIG. 2. Instead, the play module uses data in the distribution list from the distribution agent 370 and the news update to produce the subscriber specific media presentation in real time when the subscriber requests the news update.

Event Manager 440 supports incremental addition of users to existing news events. Such activity enables upstream systems to perform batch processing of subscribers by sending a news update with just the “premium” subscribers first followed by subsequent lists of “non-premium” subscribers. Efficient bandwith utilization is accomplished because any multi-media files required by the news update are sent only with the first distribution list.

Upon receiving an event from the distribution manager 400, Event Manager 440 catalogs the incoming event (text and multi-media). The structured data associated with the event goes to the Local Event Library 452. Subscriber, provider, and publisher preference data goes into the local Subscriber Library 454. The syncing of local Multimedia 458 and Placeholder Libraries 456 with upstream master libraries 390 is either triggered by an incoming news event, as in the case of the system in FIG. 2, or performed periodically.

A DTD for financial news events sent from distribution manager 400 in FIGS. 1 and 2 to Event Manager 440 is shown on Page 47 (Note that other components of the invention serve to customize the delivery of such information in order to provide a richer presentation. Those components will be discussed in detail below.):

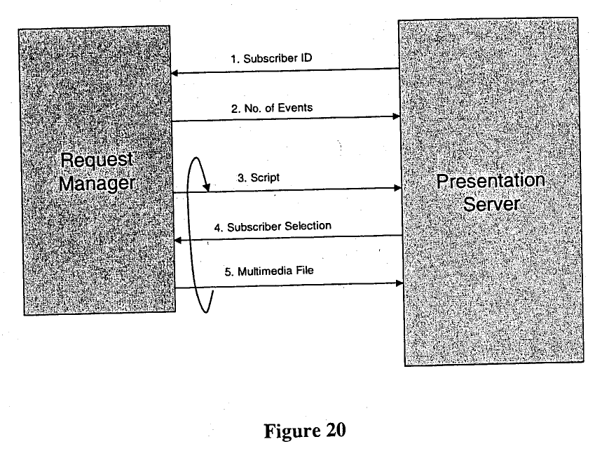

As shown, Event Manager 440 receives and manages data from an upstream system. Request Manager 480 is the component of the play module that manages a subscriber session when a subscriber requests his/her media presentation. This includes accepting subscriber identification from the presentation server, downloading a script to the presentation server, providing the other components of the play module the data necessary to produce required media, and on receiving subscriber selections, instructing the presentation server which media files to download and play to the subscriber. Request Manager recognizes the subscriber based on the subscriber's identification. Upon recognition, Request Manager pulls subscriber-specific events from either Event Manager or the local Event Library and provides the subscriber-specific event to the other components of the play module for processing. FIG. 20 is a schematic that depicts the interactions between the Request Manager 480 and the presentation server 600. The following is an example in an embodiment of how a subscriber accesses his/her presentation server to request the presentation and the process for producing and delivering the presentation:

1. Request Manager receives a subscriber identification (ID) from a presentation server for the subscriber requesting his/her presentation;

2. Request Manager computes the number of messages waiting for a subscriber and plays an introductory message telling the subscriber how many events are waiting to be heard;

3. Request Manager sends a script that instructs the presentation server to present the subscriber a list of options to choose from. If the listener does not select an option, the system uses the subscriber's default delivery preferences;

4. Request Manager receives the subscriber-selected option and uses the other system modules to prepare a media file; and

5. (a) instructs the presentation server to play the media file to the subscriber; and

(b) repeats steps (4) and (5) until there are no more media files to be played to the subscriber.

Request Manager is able to communicate with the presentation server using any data format that enables a presentation server to accept a script from Request Manager, to present a set of options to the subscriber, that informs Request Manager which option a subscriber has selected, and that enables Request Manager to specify the location from where the presentation server can download a media file. One communication format that can perform the above-listed tasks is VoiceXML. The presently preferred implementation supports interaction with presentation servers using VoiceXML, however the invention is not limited to VoiceXML as other communication formats can be used.

As described above, Event Manager receives, manages, and stores in the local libraries, data from an upstream system. The local libraries are Event Library 452, Subscriber Library 454, Placeholder Library 456, and Multimedia Library 458. Request Manager manages the interaction between subscriber and the other components (except Event Manager) of the play module. Those components: Playlist Sequencer 470, Remediation Agent 472, Presentation Item Composer 474, and Media Composer 476 are described below.

Playlist generation rules, i.e. play sequencing rules, may be either domain dependent or domain independent. Such rules may or may not reside locally. Rules that do not reside locally in the play module may be accessed through remote calls. The above is true for all rules in the system. Such an architecture facilitates the development of custom rules. Note that specific playlist generation rules and the components of the play module implementing such rules are described in FIG. 22 and are discussed below.

Playlist Sequencer 470 accepts a subscriber's selections entered during the current session; (2) accepts a subscriber's default delivery and content preferences; and (3) accepts a list of events; and (4) returns the next set of events to be converted into a media presentation and delivered to the subscriber. The size of the set of returned events can be set at deployment time or varied based on the subscriber ID, call time, or the load on the system. The size should be set to ensure that messages are delivered in real time to a subscriber. The factors that determine the order of the messages include time of the actual event, time that the subscriber is retrieving the event, domain ordering, and so on. For example, a subscriber may prefer to get the financial messages before sports and weather. If there exists some financial events, the other events are ruled out from being the next event to be played. Of the financial messages, a subscriber may want a wrap-up done before going into individual developments. Such a wrap-up becomes the next file to be played. In the absence of any sorting preferences within a domain, the system may select the event relating to a stock in which the subscriber has the largest investment. In an embodiment, Playlist Sequencer minimizes the time a subscriber spends waiting for a message to be played. Based on an input parameter N, Playlist Sequencer returns the next N messages to be played to the subscriber. Request Manager thus has a queue of 3 messages to be played to the subscriber by calling Playlist Sequencer with parameter N set to 3. When a message is played, Request Manager updates the queue with one more message by calling Playlist Sequencer with N=1. At all times, there is a queue of N messages waiting for the subscriber. Therefore, if a subscriber skips a message, the next message can be played to the user quickly.

Another component of the presently preferred implementation of the play module is the Remediation Agent 472. Remediation Agent accepts an input list of events, a reference event, and returns an output list of events. The reference event may be modified as the Remediation Agent is constructing the output event list. In alternate embodiments, Remediation Agent also accepts subscriber preferences and a history of subscriber selections for the current session. Remediation Agent considers each event in the input list and performs one of four possible actions:

1. If the current event is obsolete with respect to the reference event, then it is not included in the output event list. For example:

a. If reference event is a price update on IBM stock sent at 3 pm and

b. Current event is a price update on IBM stock sent earlier at 11 am,

c. Current event is marked “obsolete” and not added to the output list. No modification is made to the reference event in this scenario.

2. If the current event is redundant with respect to the reference event and it is not included in the output event list. For example:

a. If reference event is a news update from Reuters on “IBM appoints new CEO”,

b. Current event is a news update from AP on “IBM appoints new CEO”, and

c. Reuters is the primary content provider as per subscriber preferences,

d. Current event is marked redundant and not added to the output list. Just as in the case of obsolete events, no modification is made to the reference event.

3. If the current event can be combined with the reference event, the reference event is updated accordingly and the current event is not included in the event list. For example:

a. If reference event is an update from subscriber's bank on Apr. 12, 2002 with the information that check #150 has been cashed and the current balance is $3000,

b. Current event is an update from the same bank on Apr. 2, 2002 with the information that check #148 has been cashed and the current balance is $3500,

c. Reference event is updated to inform that checks #148 and #150 have been cashed and the latest balance is $3000. Once again, the current event is not added to the output list.

Once the next event to be played to a subscriber has been identified, Request Manager 470 can then call Remediation Agent with this event as the reference event and remove events in the playlist that are obsolete, redundant, or have been merged into the reference event. The redundant and obsolete events can be delivered only if the subscriber insists on receiving such information as part of his/her presentation.

In one embodiment, Remediation Agent 472 iterates through the input list of events one by one. For each candidate, it applies all relevant rules that use properties of the candidate event, the reference event and the subscriber preferences. Application of a playlist generation rule compares the candidate event with the reference event and determines whether the candidate event is redundant, obsolete, can be merged with reference event, distinct from reference event, or inconclusive. In this embodiment, a playlist generation rule is an object with a method that evaluates a candidate event with respect to a reference event and subscriber profile and classifies the event as either REDUNDANT, OBSOLETE, CAN_BE_MERGED, DISTINCT, or UNDECIDED. For an event to be assigned as redundant, at least one applicable rule has to determine that the event is REDUNDANT, and no rule should determine that the event is DISTINCT. An event is determined to be obsolete in a similar fashion. However, for an event to be merged with the reference event, at least one applicable rule has to determine that the event is CAN_BE_MERGED. Such a rule also has to provide a method for merging the candidate event with the reference event.

The next component of the play module is a Presentation Item Composer. At this point it is necessary to describe the presently preferred embodiment of constructing presentation items, and ultimately playlists, from structured and unstructured events together with distribution data, subscriber preferences, publisher preferences, and provider preferences. The discussion of FIG. 14 describes how the play module selects sentence templates containing pointers to media segments, the play module constructing sentences therefrom. The presently preferred implementation of the invention is able to construct sentences for presentation in the same way. However, in the presently preferred implementation, sentence templates belong to a superset of placeholders that are used by the play module to construct a presentation. Those placeholders, which include paragraphs, sentence templates, sub-templates, and categories are shown in FIG. 22. Each presentation item 475A is comprised of or more paragraphs 475B. Each paragraph 475B is comprised of one or more sentence templates 475C. Each sentence template 475C is comprised of a list of sub-templates 475D. Each sub-template contains one or more categories 477A. For each category, there are multiple media segment IDs, of which one is chosen using rules to fill the category. For some categories, if all candidate media segments convey the same meaning, a media segment ID may be chosen at random from the available media segment IDs. For example, a category that describes upward movement of a stock can have audio segment IDs for the phrases “rose”, “went up”, and “increased”. The following discussion of the implementation of the Presentation Item Composer will elucidate the preferred implementation of construction of a subscriber-specific presentation, as the Presentation Item Composer is the integral component in presentation construction.

An event consists of one or more paragraphs. For example, a news update event about a stock could consist of one header paragraph, a full or summary version of the news article, a recording of an analyst's view of the news event, a discussion of the subscriber's holdings in the stock, and finally a paragraph giving instructions to the subscriber if he/she wishes to act based on the news event delivery.

Some paragraphs such as news summary and news analysis are unstructured data and thus have pre-recorded media files associated with them, while other paragraphs fall under the category of structured data and, in the case of an audio presentation, are converted to audio by a second conversion means. In a preferred embodiment, this conversion is achieved by concatenating a series of pre-recorded audio segments. It is the Presentation Item Composer 474 that accepts a candidate event, subscriber profile, along with text and associated media files and outputs a set of media IDs that correspond to either a recording or a media segment in the correct media format.

For unstructured data that is delivered to the play module with an attached media file, Presentation Item Composer returns the attached media file. This flexibility enables the play module to service upstream systems that have their own media conversion means. If there is a set of media files attached to the event, Presentation Item Composer uses playlist generation rules to deliver a subset of the files based on the subscriber profile, time of the data request and the event itself. For example, if the subscriber is accessing a news event from a cell phone, Presentation Item Composer returns a summary. If the subscriber is requesting the same event from a telematic device, Presentation Item Composer returns a recording of the full news article.

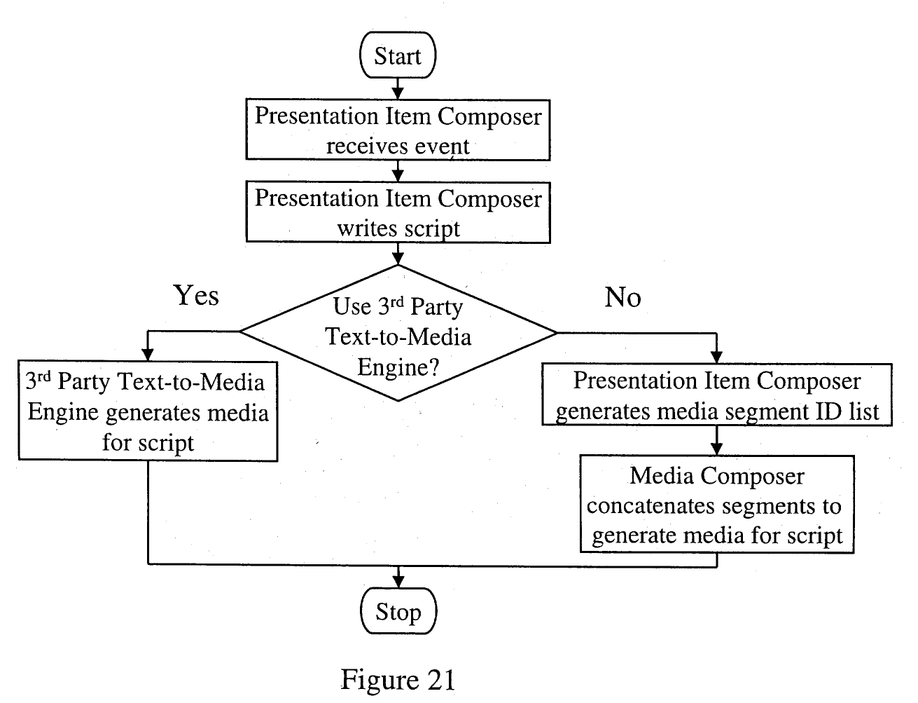

For structured data to be part of a media presentation, FIG. 21 shows output from Presentation Item Composer may either be fed to a 3rd party text-to-media conversion engine, or to Media Composer 476 for concatenation of audio segments. If a 3rd party text-to-media conversion engine is used, Presentation Item Composer constructs a script and passes it on to the conversion engine for producing the associated media file. Else, Presentation Item Composer returns both a script and a list of media segment IDs for Media Composer to use to retrieve media segments and concatenate.

For structured data, Presentation Item Composer selects a placeholder paragraph from a pre-determined pool of paragraphs that represent all the different types of information to be presented to the subscriber. The playlist generation rules that govern this selection are called presentation item generation rules, which are depicted in FIG. 22 as 474A. For example, for a price update, the paragraph is chosen from this pool by the type of event, the trigger occurring in the event, subscriber preferences, and special case information. In order to introduce variety in the presentation, a paragraph is chosen at random from a list of paragraphs that are valid for the type of structured data being delivered to the subscriber.

The selected paragraph contains a list of sentence templates that compose the paragraph. The Presentation Item Composer then uses discourse generation rules, depicted in FIG. 22 as 474B, to iterate through the sentence templates and fill them in one by one. If an event has multiple triggers associated to it, when the trigger comparison sentence template in the paragraph is reached, additional trigger comparison sentence templates are added into the paragraph to handle the additional triggers. Subscriber preferences can determine which sentence templates within a paragraph will be filled, to provide the user with more control over the amount of information presented to them.

A sentence template consists of data about the sentence template and the list of placeholder subtemplates that comprise it. Subtemplates can consist of one or more categories. Presentation Item Composer fills subtemplates using function specific rules, depicted in FIG. 22 as 474C. The subtemplates in a sentence template are filled in a specific order, depending on, if it represents a constant phrase, if it is dependent on its location within the sentence template, if it requires data to choose the correct audio segment, if the intonation of the segment is critical, or if it is dependent on its neighbors in the sentence template. Once a subtemplate is selected, the method for filling it depends on the type of data the subtemplate represents, examples are, but not limited to:

1. Constant segment;

2. Monetary value;

3. Numeric value;

4. Data-driven constant; or

5. Time or date.

Subtemplates contain pointers to the specific data and any logic required to manipulate that data to determine the values necessary to fill them in. This architecture gives us the option of keeping play module system domain-independent, and applying domain-dependent rules, for filling in subtemplates, by performing remote method calls on upstream systems. The subtemplate fetches the data it needs, and the logic within the subtemplate is used to build a list of placeholder categories that correspond to the subtemplate.

For each category, the corresponding segments are fetched, using segment mapping rules, which are depicted in FIG. 22 as 474D, based on the category, and the voice, language, or other media required. In many cases, multiple instances of the correct segment are returned, and one is chosen randomly to add variety to the presentation without affecting the content.

Once Presentation Item Composer has selected all the segments, it can construct both the script and the list of media segment IDs by iterating through the selected media segments. Presentation Item Composer can then return either just the script or the script and list of media segment IDs.

Media Composer accepts as inputs a list of media segment IDs in a media format type. Media composer retrieves media segments corresponding to the ID in the specified media format. In the case of audio, Media composer concatenates the audio segments and outputs an audio file to be played to the subscriber. In some implementations, Media Composer may use media formatting rules, depicted in FIG. 22 as 467A, to decide which media format to select. This, in the case of audio formats and other media formats, isolates dependency of the multimedia presentation format to just one module of the system.

Returning to FIG. 22, that figure is a depiction of an embodiment of the invention showing the various levels of presentation organization and the relationship of each component of an embodiment of the play module to 1) the playlist generation rules implemented. by that component; and 2) the level of presentation at which that component implements such rules. As described above, the playlist is the ordered list of delivery items (structured or unstructured news, advertisements, sponsorship messages, etc.) to be played during a single audio and/or visual transmission to a single subscriber. In this embodiment, the play module organizes a playlist as a series of presentation items. Each presentation item corresponds to an event from an upstream system with the subscriber as a member of the event's distribution list. As discussed above, each presentation item 475A is comprised of or more paragraphs 475B. Each paragraph 475B is comprised of one or more sentence templates 475C. Each sentence template 475C is comprised of a list of sub-templates 475D. Each sub-template contains one or more categories 477A. For each category, there are multiple media segment IDs, of which one is chosen at random to fill the category. For example, a category that describes upward movement of a stock can have media segment IDs for the phrases “rose”, “went up”, and “increased”.

Rules apply to different levels of the presentation. For instance, some rules determine how events are ordered and others may determine which segments are concatenated for a single sentence. Parameters used by the rules or the rules themselves can be set by one or more entities: subscriber, data source, carrier, content provider etc.

As described above, Playlist Sequencer 470 determines the sequence of events to be presented. To do this, Playlist Sequencer user playlist sequencing rules 470A. Remediation Agent determines and tags events that present the same information by using playlist filtering rules 472A. Presentation Item Composer 474 applies rules, i.e., presentation item generation rules 474A, discourse generation rules 474B, template generation rules 474C,function specific rules 474D, and segment mapping rules 474E that govern what media segments are used for the presentation item corresponding to an event, and Media Composer, in an embodiment, employs media formatting rules 476A to select media segments in the format requested by the presentation server.

The presently preferred embodiments described here assume that an event has a distribution list associate with it. This distribution list may be provided by the data source or constructed by Distribution Agent and is ultimately the event and associated distribution list is received by Play module. In an alternate embodiment, an event does not have a distribution list of subscribers associated with it. Subscriber preferences and events sent from the data source are ultimately received by Play module. Router directs subscriber preferences and events downstream and there is no need for a Distribution Agent that stores subscriber preferences and events, and augments or constructs distribution lists. If a database module is used instead of a Router to receive subscriber and even data from a data source, a Distribution Agent is required to construct data frames for incoming structured event data and pass on structured and unstructured data to Distribution Manager. Once again the Distribution Agent does not need to store subscriber data, or augment or construct distribution lists for events.

In this embodiment, when a subscriber requests his/her presentation, Play module determines which events need to be presented to the subscriber and a presentation is constructed as described in the previously presented embodiments. The Play module may process incoming events to match them with subscriber preferences or profiles to determine which subscribers receive the incoming event. This pre-processing is not a necessary, but preferable. In this embodiment where Play module receives events with no distribution lists, the functions of Event Manager and Request Manager change to match the incoming events with subscribers, but the functions of all other components is as described in the presently preferred embodiment.

While presently preferred embodiments have been described and shown, the invention may be otherwise embodied within the scope of the appended claims.

What is claimed is:

1. A system for converting and delivering multiple subscriber data requests to each subscriber according to a subscriber preference comprising:
A. a router for accepting a subscriber preference, distribution lists and data in at least one of structured and unstructured format from a data source of said subscriber, creating a data frame associated with each such data, and directing any of said unstructured data to a conversion means and any of said structured data to a distribution agent;
B. a first conversion means for converting unstructured textual data to at least one of audio or visual data and storing said converted data in a multimedia database library;
C. a multimedia database library for storing converted data, templates, media segments, media advertisements, and media news;
D. at least one second conversion means for converting structured data to an associated one of at least audio, visual or video;
E. a distribution agent for receiving structured data and subscriber preference data from said router and unstructured data frames from said conversion means and storing said data, augmenting distribution lists of subscribers, provided by said data source, with rules or parameters used by said rules to organize data for playback by subscribers, and delivering data with associated distribution lists to a distribution manager; and
F. a distribution manager for managing, over at least one network to at least one of said second conversion means, the distribution of subscriber data, converted data from said multimedia database library, and any templates stored therein for structured data, for delivery to a subscriber for playback of converted audio and/or visual data.

2. A system for converting and delivering multiple subscriber data requests to each subscriber according to a subscriber preference comprising:
A. a database module for accepting a subscriber preference, distribution lists and data in at least one of structured and unstructured format from a data source of said subscriber;
B. a first conversion means for obtaining any of said unstructured data from said database module conversion means, creating a data frame associated with each such data, and converting textual data to at least one of audio, video or visual data and storing said converted data in a multimedia database library;
C. a multimedia database library for storing converted data, templates, media segments, media advertisements, and media news;
D. at least one second conversion means for converting structured data to an associated one of at least audio, visual or video;
E. a distribution agent for obtaining structured data and subscriber preference data from said data module, creating a data frame associated with each such data, obtaining unstructured data frames from said first conversion means or said database module, storing said data, augmenting distribution lists of subscribers, provided by said data source, with rules or parameters used by said rules to organize data for playback by subscribers, and delivering data distribution lists to a distribution manager; and
F. a distribution manager for managing, over at least one network to at least one of said second conversion means, the distribution of subscriber data, converted data from said multimedia database library, and any templates stored therein for structured data, for delivery to a subscriber for playback of converted audio and/or visual data.

3. A system for use with a content provider service for systematically delivering preferred content to audio and/or visual devices of multiple users comprising:
A. a router for accepting, organizing and directing data received from a publisher application program interface, said data comprising user preferences and user preferred content as structured or unstructured data frames;
B. a first conversion means to augment said unstructured data frames with additional information, said additional information including identification and content summary, and create audio and/or visual files of said unstructured data;
C. a Multimedia Library containing segments of audio, visual or a combination thereof, and for storing at least one of said unstructured data frame audio and/or visual files, profiles and commercial/advertisement information;
D. a second conversion means for converting structured data to associated audio, visual or combination thereof;
E. a distribution agent to store in a database user preferences, structured data frames and augmented unstructured data frames and distribution rules; and
F. a distribution manager for systematically delivering said associated converted data to user devices according to said distribution list and rules.

4. A system for use with a content provider service for systematically delivering preferred content to audio and/or visual devices of multiple users comprising:
A. a database module for accepting data received from a publisher application program interface, said data comprising user preferences and user preferred content as structured or unstructured data frames;
B. a first conversion means to obtain said unstructured data frames from said database module, augment said unstructured data frames with additional information, said additional information including identification and content summary, and create audio and/or visual files of said unstructured data;
C. a Multimedia Library containing segments of audio, visual or a combination thereof, and for storing at least one of said unstructured data frame audio and/or visual files, profiles and commercial/advertisement information;
D. a second conversion means for converting structured data to associated audio, visual or combination thereof;
E. a distribution agent to obtain user preferences and structured data frames from said database module, obtain augmented unstructured data frames from first conversion means or said database module, store in a database said preferences, data frames, and distribution lists; and
F. a distribution manager for systematically delivering said associated converted data to user devices according to said distribution list and rules.

5. A system for use with a content provider service for systematically delivering preferred content to audio and/or visual devices of multiple users comprising:
A. a router for accepting, organizing and directing data received from a publisher application program interface, said data comprising user preferences and user preferred content as structured or unstructured data frames, whereby said router directs said unstructured text data to one or more first conversion means for converting said text data to audio or visual files and for augmenting said data with identification and file pointer information;
B. at least one first conversion means for converting unstructured data;
C. a Multimedia Library containing segments of audio, visual or a combination thereof for communicating with said conversion means through said pointers to assemble subscriber multimedia data;
D. at least one second conversion means for converting associated converted data; and
E. a distribution manager for systematically delivering said converted data for use by respective users.

6. A system for use with a content provider service for systematically delivering preferred content to audio and/or visual devices of multiple users comprising:
A. a database module for accepting data received from a publisher application program interface, said data comprising user preferences and user preferred content as structured or unstructured data frames, whereby one or more first conversion means obtains unstructured text data for converting said text data to audio or visual files and for augmenting said data with identification and file pointer information;
B. at least one first conversion means for obtaining unstructured data from said database module and converting said unstructured data;
C. a Multimedia Library containing segments of audio, visual or a combination thereof for communicating with said conversion means through said pointers to assemble subscriber multimedia data;
D. a distribution agent to obtain user preferences and user preferred content as structured data frames from said database module and obtain said augmented unstructured data frames from said first conversion source or said database module;
E. at least one second conversion means for converting associated converted data; and
F. a distribution manager for systematically delivering said converted data for use by respective users.

7. A system for converting and delivering multiple subscriber data requests as set forth in claim 1 or 2, where the distribution agent also prepares distribution lists of subscribers to receive data according to subscriber preference data, said distribution list including rules or parameters used by said rules to organize data for playback by subscribers.

8. A system for converting and delivering multiple subscriber data requests as set forth in claim 3 or 4, where the distribution agent also compares user preferences with said data frames and assembles a distribution list using said distribution rules.

9. A system for converting and delivering multiple subscriber data requests as set forth in claim 5 or 6, where the distribution agent also compares user preferences with converted text frames and assembles a distribution list.

10. A system for converting and delivering multiple subscriber data requests as set forth in any one of claims 1-6, including at least one play module having one of said second converters for accepting said subscriber data from said distribution manager.

11. A system for converting and delivering multiple subscriber data requests as set forth in claim 7 wherein said play module includes a library database for local storage of subscriber data received from said multimedia database library.

12. A system for converting and delivering multiple subscriber data requests as set forth in any one of claims 1-6, including a subscriber profile database for supplying customizable playlist rules to said distribution agent.

13. A system as set forth in any one of claims 1-6, wherein said first conversion means comprises at least one of software enabled speech and human talent speech.

14. A system for converting and delivering multiple subscriber data requests as set forth in any one of claims 1-6, including a database for storing advertising frames for said distribution manager to deliver to subscribers on a distribution list for an advertisement associated with said advertising frame.

15. A system for converting and delivering multiple subscriber data requests as set forth in claim 11 wherein said library database contains an advertisement associated with said advertising frame.

16. A system for converting and delivering multiple subscriber data requests as set forth in any one of claims 1-6, wherein said structured data is converted to at least one segment.

17. A system for converting and delivering multiple subscriber data requests as set forth in claim 13 wherein said library database includes at least one template to structure segments to create audio and/or visual communication media.

18. A system as set forth in any one of claims 1-6 wherein said structured data comprises formulaic or numeric data.

19. A system as set forth in any one of claims 1-6 wherein said first conversion means includes an automated text to speech program or a human recording studio.

20. A system for converting and delivering multiple subscriber data requests to each subscriber according to a subscriber preference comprising:
A. a router for accepting a subscriber preference and data in at least one of structured and unstructured format from a data source of said subscriber, creating a data frame associated with each such data, and directing any of said unstructured data to a conversion means and any of said structured data to a distribution manager;
B. a first conversion means for converting unstructured textual data to at least one of audio or visual data and storing said converted data in a multimedia database library;
C. a multimedia database library for storing converted data, placeholders, media segments, media advertisements, and media news;
D. at least one second conversion means for converting structured data to an associated one of at least audio, visual or video; and
E. a distribution manager for managing, over at least one network to at least one of said second conversion means, the distribution of subscriber data, for delivery to a subscriber for playback of converted audio and/or visual data.

21. A system for converting and delivering multiple subscriber data requests to each subscriber according to a subscriber preference comprising:
A. a database module for accepting a subscriber preference and data in at least one of structured and unstructured format from a data source of said subscriber;
B. a first conversion means for obtaining any of said unstructured data from said database module conversion means, creating a data frame associated with each such data, and converting textual data to at least one of audio, video or visual data and storing said converted data in a multimedia database library;
C. a multimedia database library for storing converted data, placeholders, media segments, media advertisements, and media news;
D. at least one second conversion means for converting structured data to an associated one of at least audio, visual or video;
E. a distribution agent for obtaining structured data and subscriber preference data from said data module, creating a data frame associated with each such data, obtaining unstructured data frames from said first conversion means or said database module, and delivering data to a distribution manager; and
F. a distribution manager for managing, over at least one network to at least one of said second conversion means, the distribution of subscriber data, for delivery to a subscriber for playback of converted audio and/or visual data.

22. A system for use with a content provider service for systematically delivering preferred content to audio and/or visual devices of multiple users comprising:
A. a router for accepting, organizing and directing data received from a publisher application program interface, said data comprising user preferences and user preferred content as structured or unstructured data frames;
B. a first conversion means to augment said unstructured data frames with additional information, said additional information including identification and content summary, and create audio and/or visual files of said unstructured data;
C. a Multimedia Library containing segments of audio, visual or a combination thereof, and for storing at least one of said unstructured data frame audio and/or visual files, profiles and commercial/advertisement information;
D. a second conversion means for converting structured data to associated audio, visual or combination thereof; and
E. a distribution manager for systematically delivering said associated converted data to user devices according to said user preferences and rules.

23. A system for use with a content provider service for systematically delivering preferred content to audio and/or visual devices of multiple users comprising:
A. a database module for accepting data received from a publisher application program interface, said data comprising user preferences and user preferred content as structured or unstructured data frames;
B. a first conversion means to obtain said unstructured data frames from said database module, augment said unstructured data frames with additional information, said additional information including identification and content summary, and create audio and/or visual files of said unstructured data;
C. a Multimedia Library containing segments of audio, visual or a combination thereof, and for storing at least one of said unstructured data frame audio and/or visual files, profiles and commercial/advertisement information;
D. a second conversion means for converting structured data to associated audio, visual or combination thereof;
E. a distribution agent to obtain user preferences and structured data frames from said database module, obtain augmented unstructured data frames from first conversion means or said database module; and
F. a distribution manager for systematically delivering said associated converted data to user devices according to said user preferences and rules.

24. A system for converting and delivering multiple subscriber data requests as set forth in any one of claims 20-23, including at least one play module having one of said second converters for accepting said subscriber data from said distribution manager.

25. A system for converting and delivering multiple subscriber data requests as set forth in claim 24 wherein said play module includes a library database for local storage of subscriber data received from said multimedia database library.

26. A system as set forth in any one of claims 20-23, wherein said first conversion means comprises at least one of software enabled speech and human talent speech.

27. A system for converting and delivering multiple subscriber data requests as set forth in any one of claims 20-23, including a database for storing advertising frames for said distribution manager to deliver to subscribers on a distribution list for an advertisement associated with said advertising frame.

28. A system for converting and delivering multiple subscriber data requests as set forth in claim 25 wherein said library database contains an advertisement associated with said advertising frame.

29. A system for converting and delivering multiple subscriber data requests as set forth in any one of claims 20-23, wherein said structured data is converted to at least one segment.

30. A system for converting and delivering multiple subscriber data requests as set forth in claim 25 wherein said library database includes at least one placeholder to structure segments to create audio and/or visual communication media.

31. A system as set forth in any one of claims 20-23 wherein said structured data comprises formulaic or numeric data.

32. A system as set forth in any one of claims 20-23 wherein said first conversion means includes an automated text to speech program or a human recording studio.

33. A rule-based system for a subscriber specific media presentation:
an event manager for receiving data in at least one of structured and unstructured format;
a multimedia database library for storing said data, any placeholders for said structured data, said distribution lists, and at least one media data segment;
a subscriber request manager for recognizing said subscriber and providing said subscriber-specific media presentation to said subscriber;
a sequencing agent for receiving said data, receiving or containing a profile, and sequencing said data;
a presentation item composer for receiving said data and said any such placeholders for said structured data, wherein said data and said any such placeholders for structured data are organized by rules, the presentation item composer providing said at least one pointer corresponding to said organized data; and
a means to accept said organized data and providing media corresponding to said organized data where said media is used to provide subscriber-specific media presentation for delivery to subscriber.

34. A rule-based system for a subscriber specific media presentation as claimed in claim 33, wherein said system receives a distribution list for data in at least one of structured and unstructured format.

35. A rule-based system for a subscriber specific media presentation as claimed in claim 33 where said means is a media composer providing said media data segments corresponding to said at least one pointer thereby providing subscriber-specific media presentation for delivery to subscriber.

36. A system for converting and delivering multiple subscriber data requests to each subscriber according to a subscriber preference as set forth in any one of claims 1-6, or 20-23, wherein the second conversion means further comprises:
an event manager for receiving data in at least one of structured and unstructured format;
a multimedia database library for storing said data, any placeholders for said structured data, said distribution lists, and at least one media data segment;
a subscriber request manager for recognizing said subscriber and providing said subscriber-specific media presentation to said subscriber;
a sequencing agent for receiving said data and receiving or containing a profile and sequencing said data;
a presentation item composer for receiving said data and said any such placeholders for said structured data, wherein said data and said any such placeholders for structured data are organized by rules, the presentation item composer providing said at least one pointer corresponding to said organized data; and
a means to accept said organized data and providing media corresponding to said organized data where said media is used to provide subscriber-specific media presentation for delivery to subscriber.

37. A rule-based system for a subscriber specific media presentation as claimed in claim 36, wherein said system receives a distribution list for data in at least one of structured and unstructured format.

38. A rule-based system for a subscriber specific media presentation as claimed in claims 33 or 36 wherein said means to accept is a media composer providing said media data segments corresponding to said at least one pointer thereby providing subscriber-specific media presentation for delivery to subscriber.

39. A rule-based system for a subscriber specific media presentation as claimed in claim 33, further comprising a remediation agent receiving said data and removing data that is either obsolete or redundant.

40. A rule based system for a subscriber specific media presentation as claimed in claim 36, further comprising a remediation agent receiving said data and removing data that is either obsolete or redundant.
